(19) United States
(12) Patent Application Publication
(10) Pub. No.: US 2025/0376555 A1
(43) Pub. Date: Dec. 11, 2025

(54) TAILORED COVALENT ORGANIC FRAMEWORK MEMBRANES FOR LITHIUM EXTRACTION AND RECYCLING

(71) Applicant: University of North Texas, Denton, TX (US)

(72) Inventor: Shengqian Ma, Denton, TX (US)

(21) Appl. No.: 18/706,158

(22) PCT Filed: Oct. 31, 2022
(86) PCT No.: PCT/IB2022/060495

§ 371 Date: Apr. 30, 2024

Related U.S. Application Data
(60) Provisional application No. 63/274,327, filed on Nov. 1, 2021.

(51) Int. Cl. C08G 12/06

(52) U.S. Cl. CPC C08G 12/06

(57) ABSTRACT

Solid state nanofluidic membranes are provided that control transport of ionic species through the membranes. The membranes include channels whose design is controlled at the nanoscale level in order to tune ionic transport activity. The membranes can be designed to favor transport of one ionic species over other ionic species. The membranes are useful for separating and purifying lithium, for example, from brines containing other ionic species.

### CROSS-REFERENCE TO RELATED APPLICATION

The present application claims priority to U.S. Provisional Application No. 63/274,327 filed Nov. 1, 2021, the disclosure of which is incorporated by reference herein in its entirety.

### TECHNICAL FIELD

The present disclosure generally relates to covalent organic frameworks (COF) which are useful for separating specific ionic species from mixtures of ionic species.

### BACKGROUND

Nature has adapted over millennia to control ion transport across cellular membranes. To mimic the functions of the biological processes, solid-state nanofluidic membranes were proposed to control the transport of ionic species flowing through them. One of the fundamental factors that determine the ion transport activity is the nanoscale control of the surface chemistry of channels. For example, it has long been recognized that ionic species transport profiles can be manipulated through active regulating of surface charge density. To fully use such characteristics for more delicate separation processes, a greater understanding of the ion transport behavior, along with the varying charge distribution in the nanofluidic membranes, is essential. However, due to the lack of systematic exploration, such a correlation has yet to be established.

Recent advances in material science provide opportunities to address this goal, and a prime example is the advent of two-dimensional covalent organic frameworks (2D COFs). The programmability of this type of material offers more sophisticated, controllable separation systems relative to other currently used materials. COFs can serve as an ideal platform for creating biomimetic nanofluidic systems with controllable ion transport activity in applications ranging from water purification to energy resource recovery.

Over the past two decades, lithium has become a crucial and ubiquitous energy resource. Lithium batteries are used for portable consumer electronic devices, as well as numerous other emergent technologies, including solar power storage, electric vehicles, and uninterruptible power supplies. In order to meet the continuously growing demand for lithium, the development of technology capable of economically extracting lithium from low-grade deposits would ensure resource accessibility. The effective discrimination between Li⁺ and Mg²⁺ ions is especially problematic in lithium extraction from brine because of their similar properties. Hence, new approaches are needed for extraction and purification of this crucial energy resource.

### SUMMARY

The present inventors have discovered methods and compositions for separating cationic species from mixtures of cationic species. The methods and compositions may be used to separate and purify lithium from mixtures of salts. In some aspects, the compositions are provided in the form of covalent organic frameworks. The covalent organic framework compositions may be tuned to adjust framework structure and properties, such as cationic transport rate and selectivity. High selectivity can be achieved, for example, by accelerating the transport rate of specific cationic species while lowering the diffusion of other ions.

In some aspects, crystalline, modular covalent organic framework of formula TP_{(x+y)}EBₓBD_{y} (I) is provided, where the covalent organic framework comprises monomers TP, EB, and BD. In some aspects, x is an integer ranging from 1 to 5 and y is an integer ranging from 1 to 5. In some aspects, TP is derived from Formula 1 below:

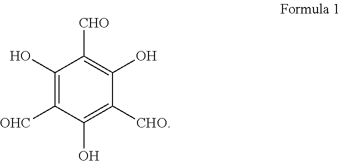 [SMILES: O=Cc1c(O)c(C=O)c(O)c(C=O)c1O]

EB is derived from Formula 2 below:

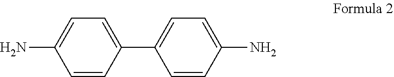 [SMILES: Nc1ccc(-c2ccc(N)cc2)cc1]

and BD is derived from Formula 3 below:

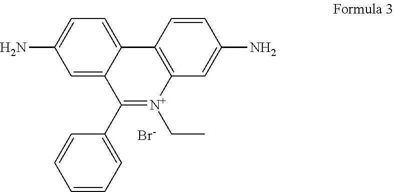 [SMILES: CC[n+]1c(-c2ccccc2)c2cc(N)ccc2c2ccc(N)cc21 ; [Br-]]

The phrase “derived from” means that the monomers present in the covalent organic framework have been subjected to polymerization, and their structures within the post-polymerized covalent organic framework are distinct from the corresponding structures of un-polymerized monomers. For example, the covalent organic framework includes imine functional groups that are derived from reaction between an amine group of one monomer and an aldehyde group of a distinct monomer. In some aspects, the covalent organic framework comprises a plurality of imine functional groups, each of which is derived from reaction between an aldehyde group and an amine group. In some embodiments, the covalent organic framework is of the formula EB₁BD₅, EB₁BD₃, EB₂BD₃, EB₁BD₁, EB₃BD₂, EB₃BD₁, or EB₀BD.

In some embodiments, the covalent organic framework has a cyclic structure and comprises a repeating unit represented by Formula 4 below:

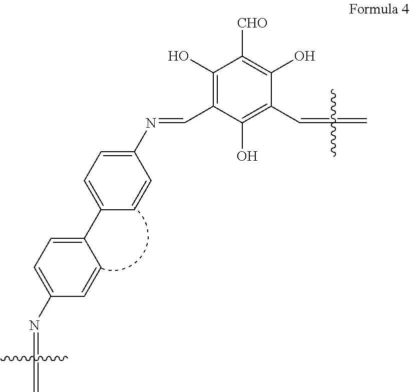

wherein the portion of Formula 4 shown in Formula 5 below:

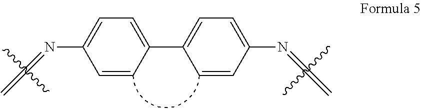 [SMILES: *=Nc1ccc(-c2ccc(N=*)cc2)cc1]

corresponds to the group within the repeating unit shown in FIG. 4 and this group represents one of BD and EB. In some aspects, the covalent organic framework is provided on a support membrane. In some embodiments, the support membrane comprises polyacrylonitrile. In some aspects, the polyacrylonitrile membrane is a partially-hydrolyzed ultrafiltration polyacrylonitrile membrane. The covalent organic framework includes cylindrical nanochannels, in some aspects. The cylindrical nanochannel diameter can vary from 0.8 nm to 4.8 nm. In some aspects, the nanochannel diameter can be 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, or 4.8 nm, or any value therein. In some aspects, the x and y values can be selected to adjust nanochannel internal diameter. In some embodiments, the x and y values can be selected to favor transport of one ionic species over other ionic species. In some embodiments, the covalent organic framework exhibits operational stability for up to 2 months under normal operation. Normal operation consists of constant diffusion, constant dialysis and/or constant electrodialysis conditions. In some embodiments, the covalent organic framework exhibits higher cationic lithium permeability over cationic magnesium permeability. This feature can be leveraged to separate cationic lithium from a mixture of cationic species that includes cationic lithium and cationic magnesium. Higher permeability of cationic lithium can be used to purify lithium.

Some aspects of the disclosure are directed to a cyclic, crystalline, covalent organic framework comprising monomer units A and B, wherein monomer A is derived from Formula 6 below:

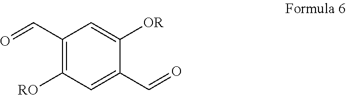

where R is an alkyl group of from 1 to 8 carbon atoms or an ethylene oxide chain comprising from 2 to 4 ethylene oxide groups, and wherein B is derived from Formula 7 below:

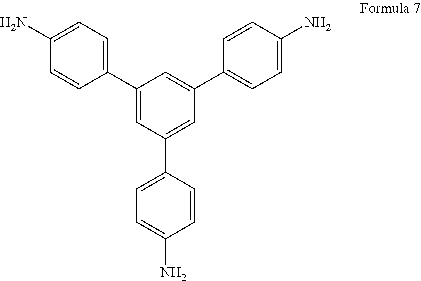 [SMILES: Nc1ccc(-c2cc(-c3ccc(N)cc3)cc(-c3ccc(N)cc3)c2)cc1]

In some embodiments, the number of A monomer units in the covalent organic framework is equal to the number of B monomer units. In some aspects, the covalent organic framework comprises a plurality of imine functional groups, each of which is derived from a monomer A aldehyde group and a monomer B amine group. In some aspects, the covalent organic comprises a repeating unit represented by Formula 8 below:

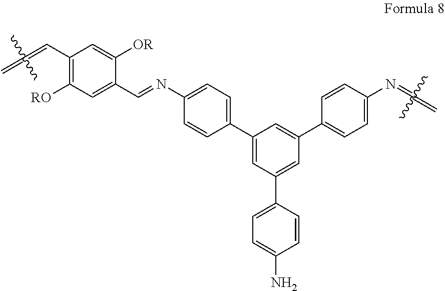

In some embodiments, the covalent organic framework comprises 6 repeating units. In some aspects, the monomer A an ethylene oxide chain terminates in a methyl group. In some embodiments, monomer A is derived from Formula 9 below:

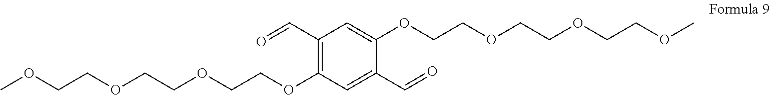

In some embodiments, monomer A is derived from Formula 10 below:

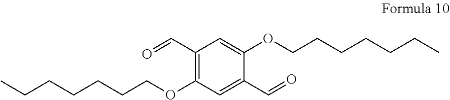 [SMILES: CCCCCCCOc1cc(C=O)c(OCCCCCCC)cc1C=O]

In some embodiments, monomer A is derived from Formula 11 below:

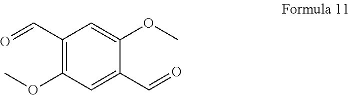

In some aspects, the covalent organic framework exhibits higher permeability to cationic lithium over cationic magnesium. The higher permeability of one ionic species over a different ionic species confers selectivity of one ionic species over different ionic species. In some embodiments, the covalent organic framework exhibits operational stability for up to 2 months under constant diffusion dialysis and electrodialysis conditions.

Some aspects of the disclosure are directed to methods for separation of a cationic species from a mixture of cationic species. In some embodiments, the method includes employing a filtration membrane comprising a polyacrylonitrile support and a covalent organic framework of formula TP(x+y)EBxBDy (I) provided on the support, where TP is derived from Formula 12 below:

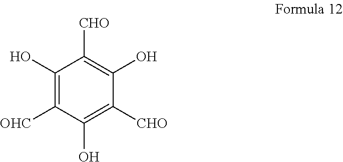 [SMILES: O=Cc1c(O)c(C=O)c(O)c(C=O)c1O]

EB is derived from Formula 13 below:

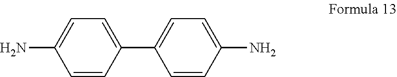 [SMILES: Nc1ccc(-c2ccc(N)cc2)cc1]

BD is derived from Formula 14 below:

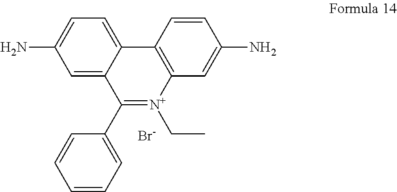

where x is an integer ranging from 1 to 5, and y is an integer ranging from 1 to 5. In some embodiments, the ratio of x:y is adjusted to adjust selectivity of a particular cationic species through the membrane. In some aspects, the method includes separating cationic lithium from a mixture of cations. In some embodiments, the mixture of cations includes cationic lithium and cationic magnesium.

Some aspects of the disclosure are directed to a method of separating a cation from a mixture of cations, the method including employing a filtration membrane that includes employing a cyclic, crystalline, covalent organic framework including monomer units A and B, where monomer A is derived from Formula 15:

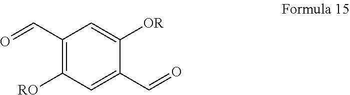

where R is an alkyl group of from 1 to 8 carbon atoms or an ethylene oxide chain that includes from 2 to 4 ethylene oxide groups, and monomer B is derived from Formula 16 below:

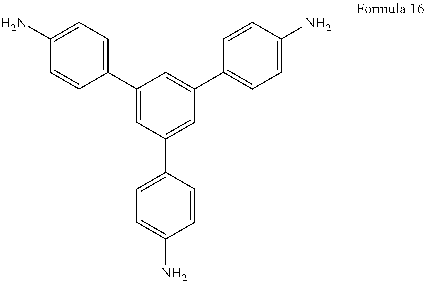 [SMILES: Nc1ccc(-c2cc(-c3ccc(N)cc3)cc(-c3ccc(N)cc3)c2)cc1]

where the number of A monomer units in the covalent organic framework is equal to the number of B monomer units, and the covalent organic framework is provided on a polyacrylonitrile support.

In some embodiments, the R group is selected to adjust selectivity of a particular cationic species through the membrane. In some embodiments, the method includes separating cationic lithium from a mixture of cations. In some aspects, the mixture of cations includes cationic lithium and cationic magnesium.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIGS. 1A-1B are (A) synthetic scheme illustration of COF-based membranes with varied charge densities via interface polymerization, and (B) diagram illustration of active regulating of surface charge density to manipulate transport profile of Li⁺ and Mg²⁺ ions.

FIGS. 2A-2B are top and cross-sectional SEM images of the partially-hydrolyzed polyacrylonitrile (PAN) membrane.

FIG. 3 is a schematic illustration of the set-up used for the fabrication of COF-based membranes via interface polymerization.

FIG. 4A-4F are SEM images of the synthesized membranes for (A) COF-BD/PAN, (B) COF-EB₁BD₅/PAN, (C) COF-EB₁BD₃/PAN, (D) COF-EB₁BD₁/PAN, (E) COF-EB₃BD₂/PAN, and (F) COF-EB₃BD₁/PAN, respectively. The scale bar equals 200 nm.

FIG. 5 is a cross-sectional SEM image of COF-EB₁BD₁/PAN.

FIGS. 6A-6F are SEM images of the surface morphologies of (A) COF-BD/PAN, (B) COF-EB₁BD₅/PAN, (C) COF-EB₁BD₃/PAN, (D) COF-EB₁BD₁/PAN, (E) COF-EB₃BD₂/PAN, and (F) COF-EB₃BD₁/PAN, respectively. The scale bar equals 100 nm.

FIGS. 7A-7B are a comparison of the IR spectra of the synthesized membrane and the monomers (A), and various membranes (B). The relative intensity of C-N originated from quaternary ammonium displayed a trend of increase along with the proportion of EB increased from 0 to 75% in the synthesis of COF-EBₓBD₁₋ₓ/PAN and the enlarged section of green rectangle.

FIGS. 8A-8F are N 1s XPS spectra of the free-standing membranes for (A) COF-BD, (B) COF-EB₁BD₅, (C) COF-EB₁BD₃, (D) COF-EB₁BD₁, (E) COF-EB₃BD₂, and (F) COF-EB₃BD₁, respectively. Two peaks located at 399.6 and 401.3 eV, which are characteristic N 1s signals for the amino N atoms (N-H, dark yellow), and quaternary ammonium N atoms (orange), respectively. The relative surface area (Sorange/Sdark yellow) increases along with the proportion of EB increase in the resulting material. Specifically, the Sorange/Sdark yellow values are equal to 0, 0.054, 0.068, 0.078, 0.087, and 0.11, for COF-BD, COF-EB₁BD₅, COF-EB₁BD₃, COF-EB₁BD₁, COF-EB₃BD₂, and COF-EB₃BD₁, respectively.

FIG. 9 is a table of Br content in COF-EBₓBD_{y}/PAN, where the unit of Br content is mmol/g.

FIGS. 10A-10B are (A) graphic view of the eclipsed stacking structure of COF-EB, and (B) XRD patterns for the free-standing COF-EBₓBD_{y}.

FIGS. 11A-11B are N₂ sorption isotherms (A) collected at 77 K and corresponding pore size distribution, and (B) based on the nonlocal density functional theory method of free-standing COF-EB1BD1. The BET surface area was calculated to be 487 m² g-1.

FIG. 12 illustrates zeta potentials of various membranes at pH=6.5.

FIGS. 13A-13D are (A) graph depicting transport rates of Lit and Mg²⁺ across various membranes and the corresponding Li⁺/Mg²⁺ selectivities under diffusion dialysis with a LiCl or MgCl₂ concentration of 0.1 M, respectively, (B) I-V curve of the synthesized membranes measured in 0.1 M salt solutions based on the concentration of Cl⁻ ions, and (C and D) the summary of V_{oc} values and their corresponding ratios obtained from (A) and (B).

FIGS. 14A-14D illustrate the concentration change of LiCl (A) and MgCl₂, (B) through COF-BD/PAN to the opposite side as a function of time, and the concentration change of LiCl (C) and MgCl₂ (D) through COF-EB₁BD₅/PAN to the opposite side as a function of time. A conductivity meter was used to record the concentration of permeated ions.

FIGS. 15A-15D illustrate the concentration change of LiCl (A), and MgCl₂ (B) through COF-EB₁BD₃/PAN to the opposite side as a function of time, and the concentration change of LiCl (C) and MgCl₂ (D) through COF-EB₁BD₁/PAN to the opposite side as a function of time.

FIGS. 16A-16D illustrate the concentration change of LiCI (A), and MgCl₂ (B) through COF-EB₃BD₂/PAN to the opposite side as a function of time, and the concentration change of LiCl (C) and MgCl₂ (D) through COF-EB₃BD₁/PAN to the opposite side as a function of time.

FIGS. 17A-17B illustrate the transport rates of Li⁺ (A), and Mg²⁺ (B) across membranes with different charge density under diffusion dialysis with various LiCl or MgCl² concentration ranged from 0.05 M to 1 M.

FIG. 18 illustrates the transport rate of Li⁺ and Mg²⁺ across various membranes and the corresponding Li⁺/Mg²⁺ selectivity under diffusion dialysis with LiCl or MgCl₂ concentrations ranging from 0.05 M to 1 M.

FIG. 19 illustrates the concentration change of 0.5 M LiCl and 0.5 M MgCl₂ through COF-EB1BD1/PAN to the permeate chamber as a function of time and the corresponding Li⁺/Mg²⁺ selectivity.

FIG. 20A-20B are (A) a schematic diagram illustrating the configuration of the set-up of electrodialysis for ionic permeation measurement, (B) binary Li⁺/Mg²⁺ and Na⁺/Mg²⁺ selectivities of COF-EB₁BD₁/PAN over various conditions, where the left section shows the 1:1 binary solution (0.1 M each) of LiCl and MgCl₂, the middle section shows the 1:1 binary solution (0.1 M each) of NaCl and MgCl₂, and the right section shows artificial brine with the mass ratio of magnesium (29.9 g L⁻¹) and lithium (0.85 g L⁻¹) of about 35.

FIG. 21 is a table of Zeta potentials of COFs dispersed in water.

FIGS. 22A-22B illustrate standard curves showing the integral areas in ion chromatography of different concentrations of Li⁺ (A), and Mg²⁺ ions (B) with a R² value of 1.

FIG. 23 is a diagram of electrodialysis stack for measuring cation permselectivity.

FIGS. 24A-24B are (A) a diagrammatic sketch of ion channels in nature, and (B) schematic illustration of the construction of lithium channels using 2D COF as a designer platform by implanting lithiophilic functionalities. The Li ion transfer was enhanced while other ions were obstructed, allowing for high selectivity as well as permeability.

FIG. 25 is a solid-state ¹³C NMR spectrum of the free-standing COF-OHep membrane. The peak ascribed to the aldehyde group at around 170 ppm disappeared in the solid-state ¹³C NMR of the free-standing COF-OHep membrane, supporting that no detectable monomers are trapped in the membrane.

FIGS. 26A-26E are (A) cross-sectional SEM image for COF-4EO-PAN, top view (B), cross-sectional view (C) of the polyacrylonitrile (PAN) membrane, top view (D), and cross-sectional view (E) of COF-4EO-PAN.

FIG. 27 illustrates the free-standing COF-4EO membrane which was achieved by dissolving the PAN support using DMF.

FIG. 28 illustrates the powder X-ray diffraction (PXRD) pattern of free-standing COF-4EO membrane achieved by dissolving the PAN support.

FIG. 29 is a solid-state ¹³C NMR spectrum of the free-standing COF-4EO membrane. The peak ascribed to the aldehyde group at around 170 ppm disappeared in the solid-state ¹³C NMR of the free-standing COF-4EO membrane, supporting that no detectable monomers are trapped in the membrane.

FIG. 30 illustrates the Grazing-Incidence Wide-Angle X-ray Scattering (GIWAXS) pattern for COF-4EO-PAN.

FIGS. 31A-31B illustrate the relative ion permeability investigation, with I-V plots for (A) COF-4EO-PAN, and (B) COF-OHep-PAN under asymmetrical salt solutions with the cis side being filled with MgCl₂ aqueous solution and the trans side being filled with KCl, NaCl, LiCl, MgCl₂, or CaCl₂. The concentrations of Cl ions are maintained at 1 mM.

FIGS. 32A-32B are (A) schematic diagram of ion permeation through COF-4EO-PAN in a homemade diffusion cell, where a binary salt solution containing LiCl and MgCl₂ as a feed solution and H₂O as a permeate solution, and (B) illustration of concentration change of single salt (0.1 M LiCl or 0.1 M MgCl₂) through membranes to the opposite side as a function of time for COF-4EO-PAN. The ion concentrations were determined by ion chromatography.

FIGS. 33A-33B illustrate the concentration change of single-salt through membranes to the permeate chamber as a function of time over various membranes, with (A) 0.1 M LiCl, and (B) 0.1 M MgCl₂.

FIG. 34 is a table with atomistic coordinates for the AA-stacking mode of COF-4EO optimized using Forcite method (space group P6, a=b=37.7084 Å; c=3.5605 Å, α=β=90° and γ=120°).

FIG. 35A-35B illustrate lithium and magnesium separation performance tests for COF-OMe-PAN (A), and COF-OHep-PAN (B), particularly concentration change of binary salt (0.1 M LiCl and 0.1 M MgCl2) through membranes to the permeate chamber as a function of time for (A) COF-OMe-PAN and (B) COF-OHep-PAN (middle, Li⁺; lower, Mg²⁺; upper, Li⁺/Mg²⁺). Insets are graphic views of the slipped AA stacking structure of COF-OMe and COF-OHep.

FIG. 36 illustrates static solid-state ⁷Li NMR of LiCl and after association with COF-4EO and COF-4OHep. The chemical shifts of LiCl and its corresponding complexes with EO segments were centered at ˜0 ppm.

FIG. 37 illustrates water contact angles and the corresponding photographs of water droplets on the surface of COF-4EO-PAN, COF-OMe-PAN, and COF-OHep-PAN.

FIGS. 38A-38B illustrate ion transmembrane conductance investigation for Li (A) and Mg (B). The transmembrane Li conductance deviates from bulk value (dashed line) from below ˜1 mM, whereas the transmembrane Mg conductance is close to that of the bulk solution for COF-4EO-PAN.

FIGS. 39A-39C illustrate structural characterization of COF-OMe. Graphic views from top (A), and side (B) of the slipped AA stacking structure of COF-OMe (blue, N; gray, C; pink, O), and X-ray powder diffraction (XRD) profiles (C).

FIGS. 40A-40B illustrate the binary salt separation performance test. Lithium and magnesium separation performance tests for COF-4EO-PAN were run in a closed system and a cycling system. The concentration change of binary salt (0.1 M LiCl and 0.1 M MgCl₂) through COF-4EO-PAN to the permeate chamber and the corresponding separation factor as a function of time in a closed system are shown in (A), and in a cycling system (B, middle, Li⁺; lower, Mg²⁺; upper, Li⁺/Mg²⁺).

FIG. 41 illustrates the flux change of binary salt (0.1 M LiCl and 0.1 M MgCl₂) through COF-4EO-PAN to the permeate chamber as a function of time (upper, Li⁺; lower, Mg²⁺).

FIG. 42 illustrates the impact of salt concentration on the seperation performance of COF-4EO-PAN. The flux and separation factor as a function of salt concentration were evaluated under dialysis conditions after 1 h.

FIG. 43 illustrates the impact of solution pH on the seperation performance of COF-4EO-PAN. The flux and separation factor as a function of solution pH were evaluated under dialysis conditions after 1 h using 0.1 M LiCl and MgCl₂ as a feed solution. The solution pH values were adjusted by HCl or LiOH.

FIG. 44 illustrates schemes for syntheses of COF monomers.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Various features and advantageous details are explained more fully with reference to the non-limiting aspects that are illustrated in the accompanying drawings and detailed in the following description. Descriptions of well-known starting materials, processing techniques, components, and equipment are omitted so as not to unnecessarily obscure the implementations in detail. It should be understood, however, that the detailed description and the specific examples, while indicating various aspects, are given by way of illustration only, and not by way of limitation. Various substitutions, modifications, additions, and/or rearrangements will become apparent to those skilled in the art from this disclosure.

The desire to mimic cell membranes with meticulous control over ion transport has attracted significant research interest for decades. The spatially well-arranged binding sites in the ion channels enable rapid transport and high selectivity. However, most synthetic membranes that are capable of discriminating ions are functionalized with charged moieties. The main underlying principle for ion selectivity across these membranes is Donnan exclusion, whereby the membranes reject co-ions as the excess charge and transport counter-ions. Because of the charge repulsion involved in the separation process, the transport of co-ions slows down when approaching a charged membrane. Therefore, there is a need to develop novel separation layers to achieve active separation.

Lithium has become an essential resource for modern society because of the growing demand for lithium batteries in portable electronic devices and vehicles. This has rendered lithium availability a matter of energy security and the development of efficient lithium extraction technologies a growing area of interest. Given that lithium is widely distributed in salt-lake brines, considerable efforts have been made to lithium extraction.

### 1. COF-EB-BD-PAN Membrane Fabrication and Multivariate Strategy

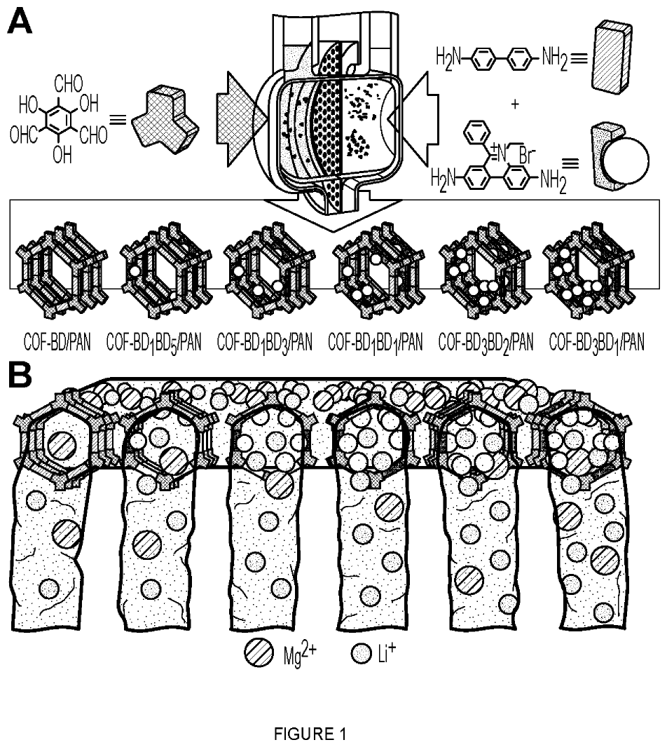

To investigate the effect of the charge distribution of nanofluidic membranes on the ion transport behavior, a multivariate (MTV) strategy was used, in which the population of a specific functionality could be readily manipulated in one COF without altering the underlying topology. To regulate the charge population in the membrane, two organic linkers with or without charge (FIG. 1A) were incorporated into one COF structure at various ratios of these two monomers to produce nanochannels with various charge densities. The influence of the surface charge density of COF channels on the transport profiles of Li⁺ and Mg²⁺ was investigated (FIG. 1B). Experimental results show that the charged groups do not always inhibit co-ions from entering the pore channels, but play a pivotal role in facilitating the translocation of Lit ions. The permeability of divalent Mg²⁺ ions is less related to the charge density of the materials, fluctuating within a small amplitude when this value falls within the range of 0.39-0.78 mmol g−1. However, by further increasing the number of charged sites, the permeability of Mg²⁺ greatly increases. The established structure-performance relationship can be applied to other separation processes and adds to the understanding of ion transport across cellular membranes. This finding provides evidence that the transport of various ionic species can be tuned by adjusting COF composition.

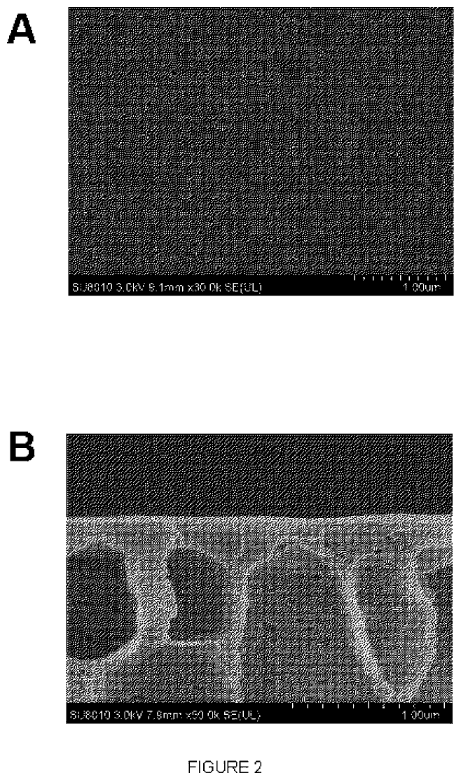

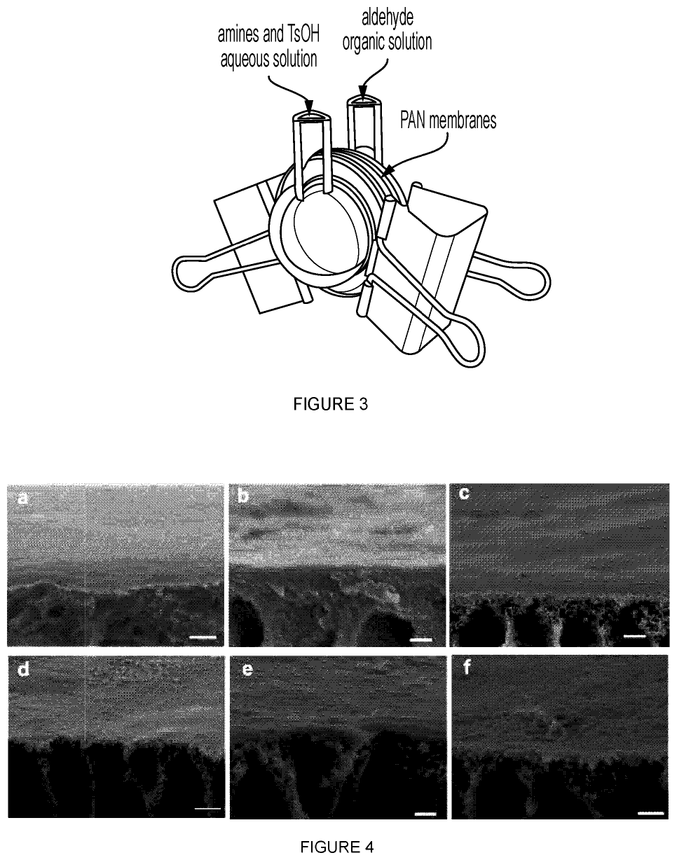

Triformylphloroglucinol (Tp) and biphenyl diamine linkers were used to synthesize MTV-COFs with varying charge densities. To increase the processibility, the COF active layers were grown on partially-hydrolyzed polyacrylonitrile (PAN) ultrafiltration membranes (FIGS. 2A-2B). The use of PAN as the support is mainly based on the following considerations: 1) PAN is flexible, which can increase the operability of the resulting membrane; 2) PAN is hydrophilic and negatively charged, which can lower the transmembrane energy of cations. Interface polymerization was adopted (FIG. 3) to achieve membranes wherein the aqueous solution contained the amine monomers (ethidium bromide (EB) and benzidine (BD)) and a catalyst of p-toluenesulfonic acid (TsOH), and the dichloromethane phase contained Tp. The resulting membranes are denoted as COF-EBₓBD_{y}/PAN, where x and y refer to the mole ratio of EB and BD in the membranes synthesis (FIGS. 1A-1B).

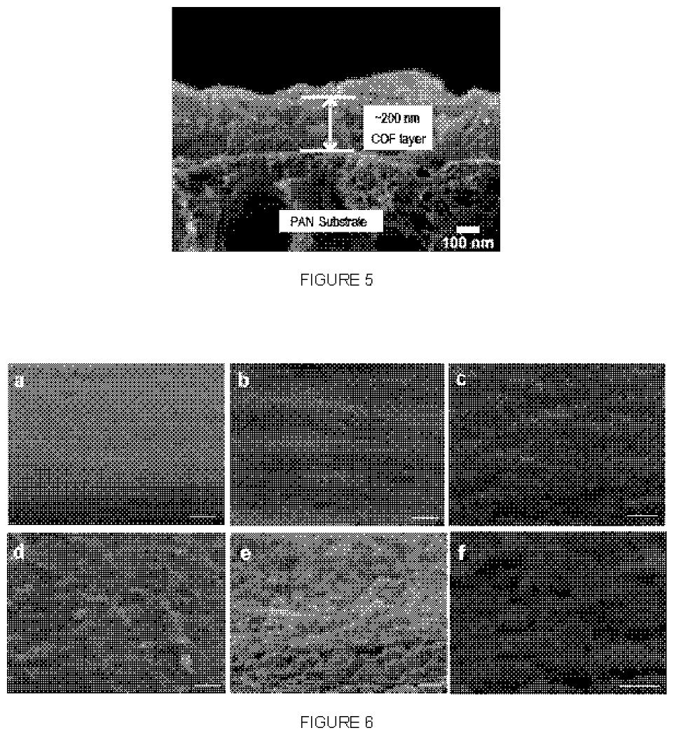

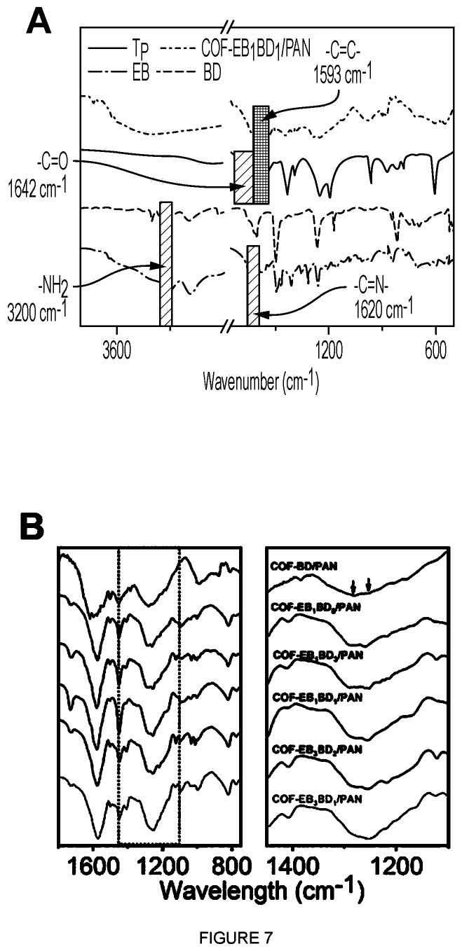

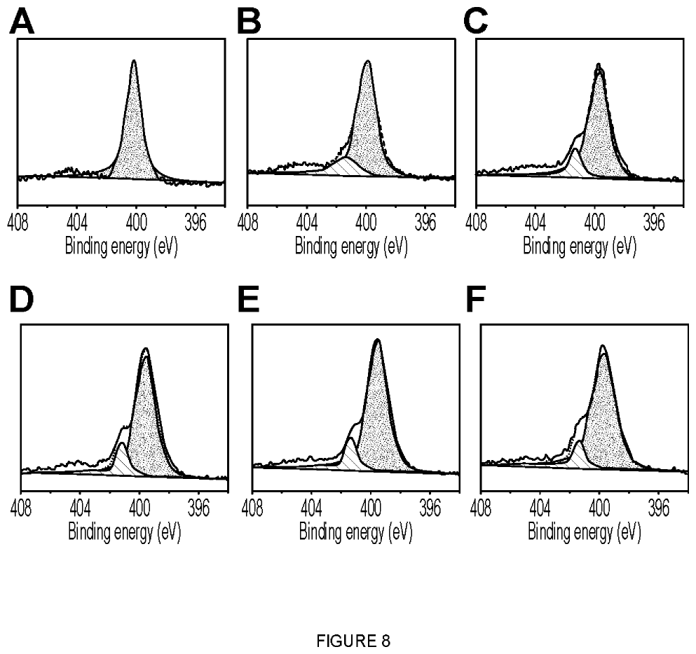

The color of the resulting membranes ranged from dark yellow to brick red as the proportion of EB increased. Scanning electron microscopy (SEM) images revealed crack-free, continuous film surfaces that contoured the underlying PAN support with a thickness around 200 nm (FIGS. 4A-4F and FIG. 5). The surface morphology of the resulting membranes was coarser with the increase of EB (FIGS. 6A-6F). The elemental mapping distribution collected by an electron microprobe analyzer showed that Br species were homogeneously dispersed throughout the membranes. Dye molecules exclusion experiments indicated that the diffusion channel size of the resulting membranes is smaller than the size of methyl blue (2.3 nm, see details in the Experimental Section). The β-ketoenamine structures of the resulting COF membranes were confirmed by Fourier transform-infrared spectroscopy (FT-IR) analysis, which showed a new peak at 1593 cm⁻¹ for −C=C along with the undetached −C=N stretch at around 1620 cm⁻¹. The disappearance of the stretching signals of the primary amine (_{VN-H}˜3200 cm⁻¹) and aldehyde (vc=o=1642 cm⁻¹) indicated the high polymerization degree of the membranes (FIGS. 7A-7B). The relative intensity of C-N originating from quaternary ammonium displayed an increasing trend, as the proportion of EB increased from 0 to 75% in the synthesis of COF-EBₓBD₁₋ₓ/PAN (FIGS. 7A-7B). The amine nitrogen 1s X-ray photoelectron spectroscopy (XPS) spectra recorded from free-standing COF-EBₓBD₁₋ₓ (x<1), exhibited two peaks located at 399.6 and 401.3 eV, which are characteristic 1s signals for the amino N atoms (N-H), and quaternary ammonium N atoms, respectively, suggestive of the successful incorporation of EB species (FIGS. 8A-8F). The relative intensity of N 1s originating from quaternary ammonium displayed an increasing trend as the proportion of EB increased from 0 to 75% in the synthesis of COF-EBₓBD₁₋ₓ/PAN.

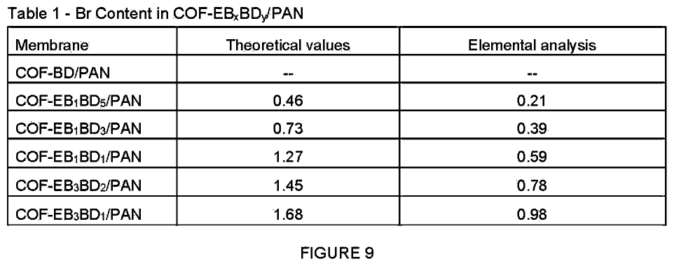

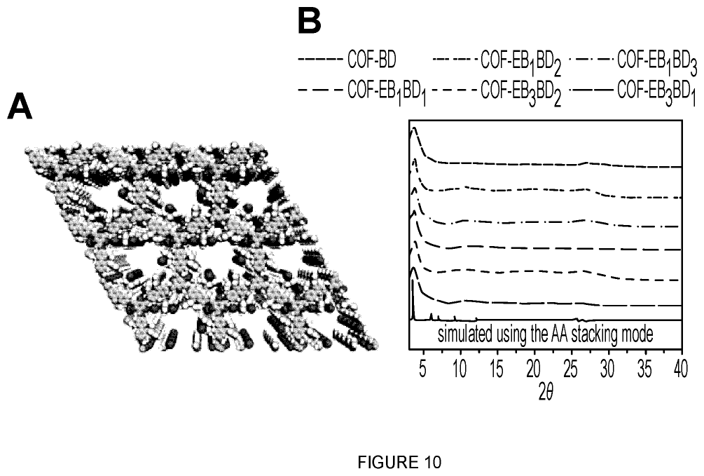

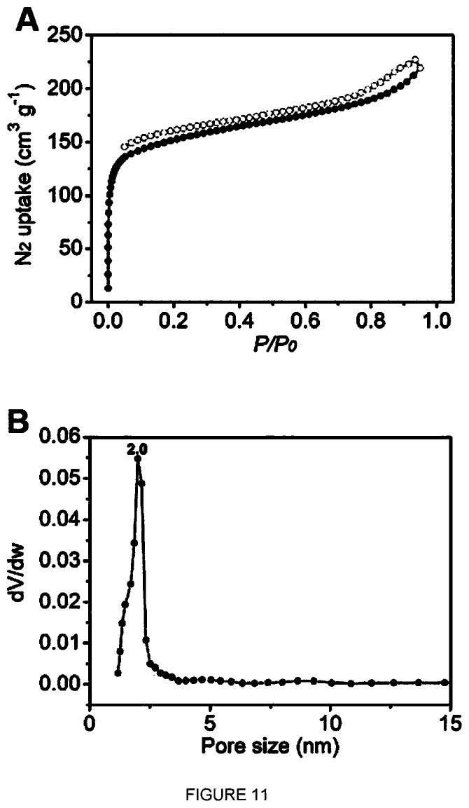

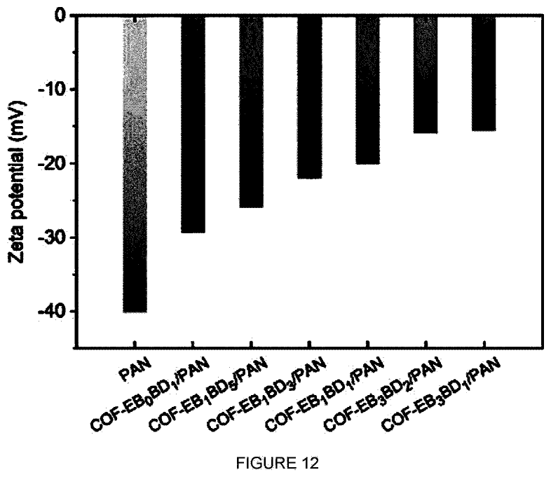

To quantify the amount of charge sites in the membranes, the content of Br species in the membranes was evaluated by ion chromatography. A positive correlation between the stoichiometry of the starting materials and the actual linker ratios in the resultant COF membranes was observed (FIG. 9), validating the XPS and FT-IR results. Powder X-ray diffraction (PXRD) analysis of the free-standing COF-EBₓBD₁₋ₓ membranes revealed crystalline structures with a prominent peak at 3.7° and a relatively broad peak at 27.1°, assigned to the (100) and (001) facets, respectively. FIG. 10A is a graphic depiction of the eclipsed stacking structure of COF-EB. The PXRD patterns for the samples were qualitatively identical to each other, verifying that they were isostructural (FIG. 10B). The diffraction patterns matched well with the calculated pattern based on the eclipsed stacking structures. N₂ sorption isotherms collected at 77 K revealed that the accessible size of the free-standing COF-EB₁BD₁ membrane is around 2 nm, in line with the eclipsed stacking model (FIG. 11A-11B). The zeta potentials of the COF-EBₓBD₁₋ₓ/PAN membranes were less negative than those of pristine PAN, varying within a small range from −25.8 to −15.6 mV for the samples containing EB, which suggested the positive charge of the COF layers and the homogeneous distribution of charged moieties throughout the pore channels (FIG. 12). This assumption was further supported by their greatly increased zeta potentials in the powder form and similar surface wettability, with wettability contact angles ranging from 69.8° to 84.2°.

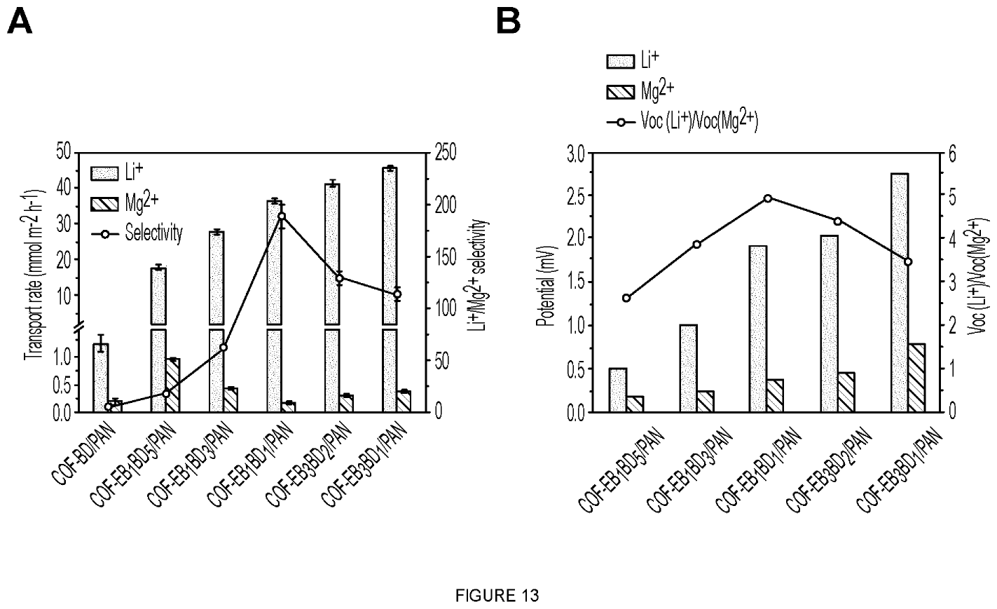

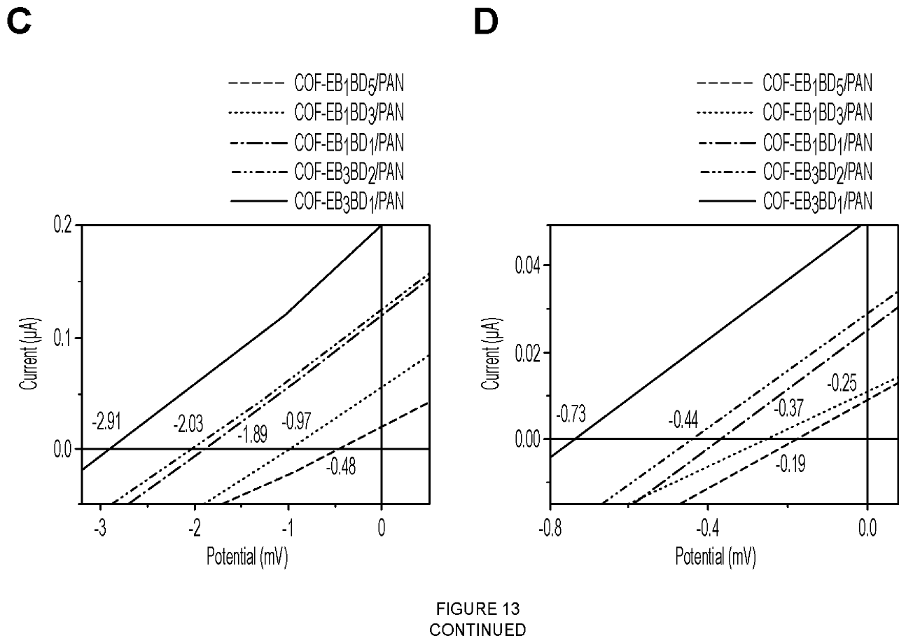

Given the restriction of Donnan exclusion and electroneutrality requirements, there are different influences of charged channels on the transport profiles of ions with different valences, which can consequently offer ion selectivity. Based upon these considerations, the separation of lithium and magnesium using these membranes was investigated. To quantitatively compare the transport activity of these membranes for Li⁺ and Mg²⁺ ions, the initial diffusion fluxes were examined. A home-made U-shaped dual-chamber diffusion cell was used. Single ion diffusion profiles were collected with a LiCl or MgCl² concentration of 0.1 M. The amount of ions transported from the feed chamber to the permeate chamber were recorded using a conductivity meter. The transport kinetics were reflected in the slope of ion concentration in the permeate chamber versus operation time. The ion diffusion flux and Li⁺/Mg²⁺ separation factor were calculated from the slope of the permeation curves. All tested membranes showed higher permeability of Lit ions than Mg²⁺ ions. Control tests were performed on the membrane in the absence of EB, which showed negligible ion transport activity, highlighting the role of charged sites as ion transporters (FIG. 13A). Correlating the initial Li⁺ and Mg²⁺ transport rates to the synthesized membranes showed that the charge density was a determinant of ion transport. The transport rate of Mg²⁺ and Li⁺ ions differed considerably in response to the varied charge densities of the membranes. The permeability of Li⁺ ions increases with an increase in the charge population, as reflected by the gradually steeper slopes. The transport of Mg²⁺ ions across the membranes was more complicated, displaying a trend of increasing, decreasing, and then increasing. COF-EB₃BD₁/PAN. The highest charge density among the membranes tested, did not exhibit the best Li⁺/Mg²⁺ selectivity, and this value was not even close to the highest (FIG. 13A). This was counterintuitive because usually, the higher the charge site concentration, the more effective the membrane is in rejecting high-valent co-ions and, consequently, the higher the Li⁺/Mg²⁺ separation factor. By comparison, COF-EB₁BD₁/PAN, with a much lower charge density, exhibited the highest Li⁺/Mg²⁺ separation factor. Considering that the COFs were isostructural, and the resulting membranes show a similar thickness, the impact of the dynamic resistance of the membrane can be excluded. Therefore, these trends were rationalized using Donnan membrane equilibrium. As electrostatic forces from the charged sites on membranes cause counter-ions to move in the direction of their concentration gradient, this leads to the enrichment of nanochannels with counter-ions and depleted co-ions. In combination with the requirement of electroneutrality, there is a competition between electrostatic repulsion of co-ions against the charged nanochannels and the electrostatic attraction from counter-ions filled in the nanochannels. Given a balanced electrostatic interaction with monovalent co-ions and counter-ions, the transport rate of Li⁺ ions accelerates as the charge density increases as more Cl⁻ ions are enriched. This is in stark contrast to the transport of Mg²⁺ ions, which exhibited an increase, decrease, and another increase in response to the increased charge density. The electrostatic repulsion that dominates the permeation of Mg²⁺ ions with the membrane charge density falls in the range of 0-0.59 mmol g⁻¹ (x/y in COF-EBₓBD_{y}/PAN is less than 1). This is because of the dielectric exclusion controls; the exclusion from a charged layer is more rigorous for a bivalent co-ion compared to a monovalent ion. However, as the charge density increases further, the attraction of enriched counter-ions dominates over the repulsion of high-valent co-ions, thereby accelerating the transmembrane permeation of Mg²⁺ ions. These factors cause the Li⁺/Mg²⁺ separation factor to increase first and then decrease. COF-EB₁BD₁/PAN appears to be the best material among this series.

To quantitatively evaluate the preferred transport of Li⁺ over Mg²⁺ ions, their relative transmembrane permeability was evaluated. Given that the potential of zero current (V_{oc}) is related to the permeability of ions in the contact solutions located at the two sides of the membrane, I-V curves were collected. To obtain the relative permeability of cations, salt solutions with the same gradient of anions were employed. Upon evaluating the V_{oc} in response to the EB proportion in the membrane, a remarkably sharp volcano-type effect was observed (FIG. 13B-13D). COF-EB₁BD₁/PAN exhibited the highest selectivity for lithium over magnesium, according to the Goldman-Hodgkin-Katz equation, which is consistent with the aforementioned results.

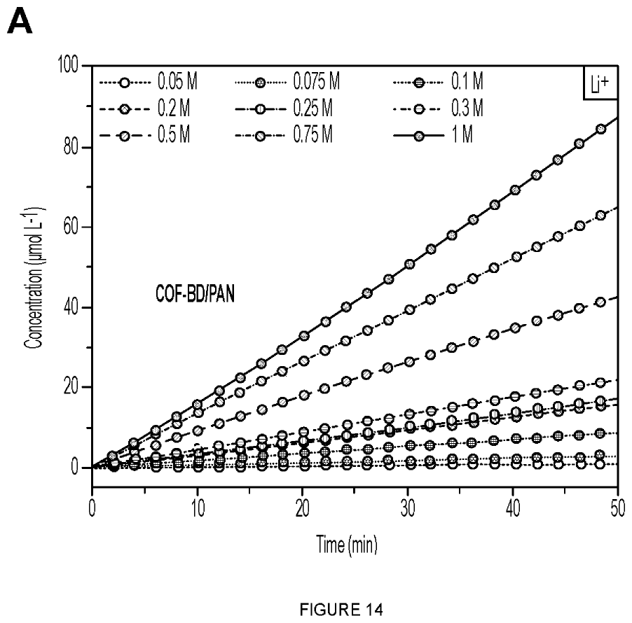

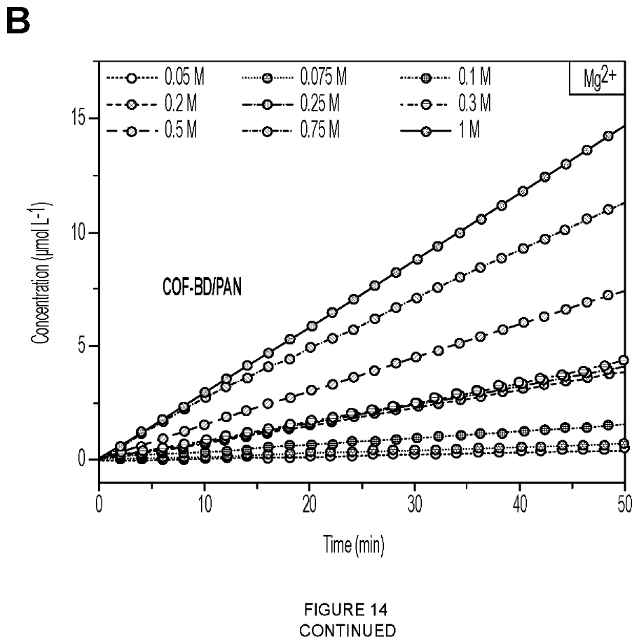

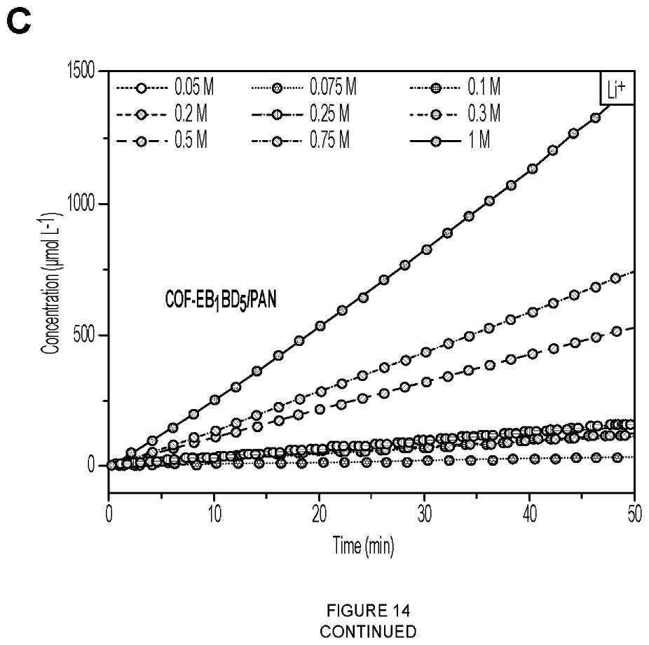

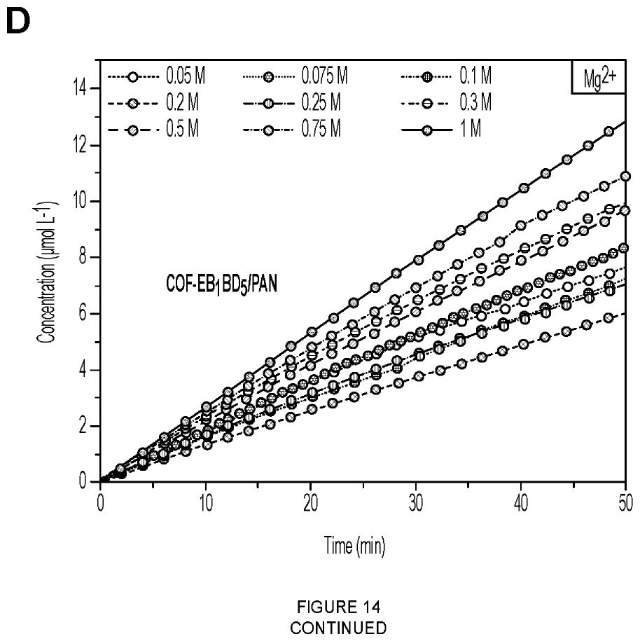

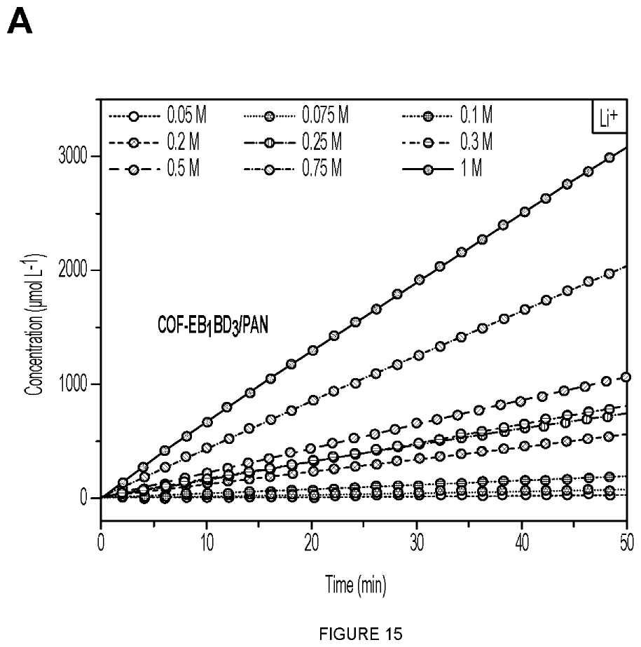

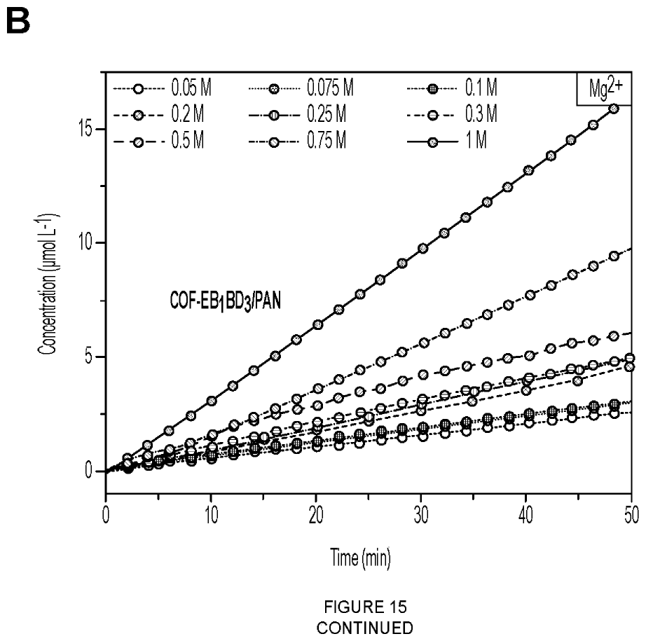

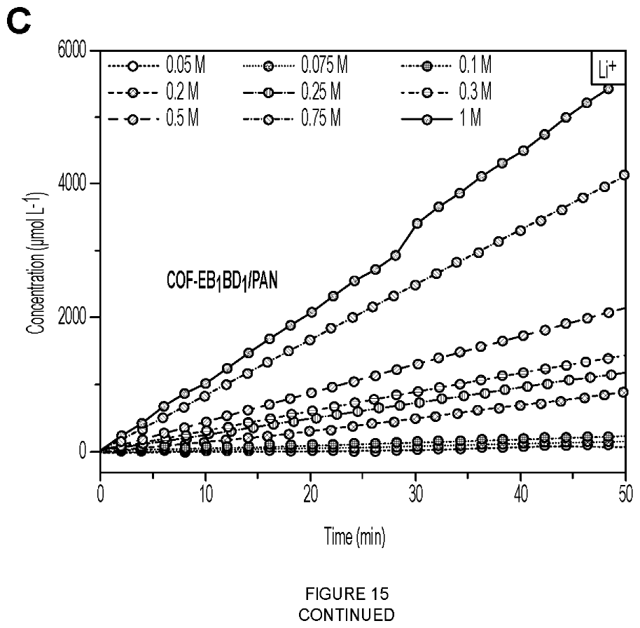

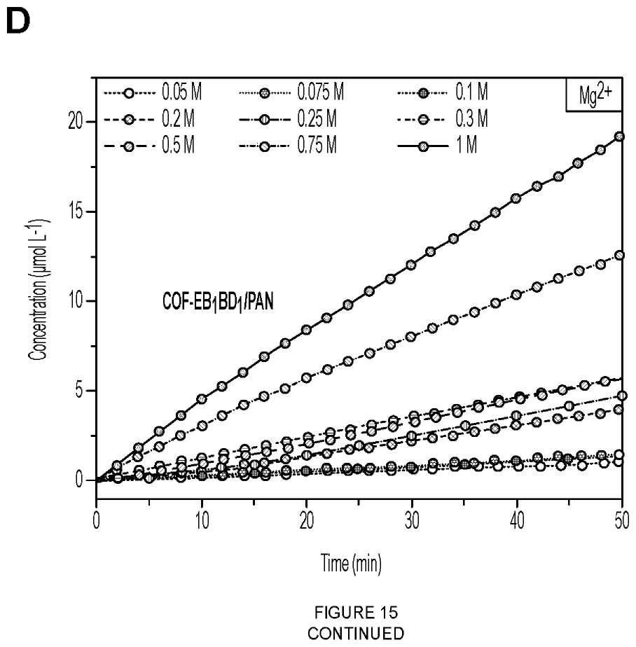

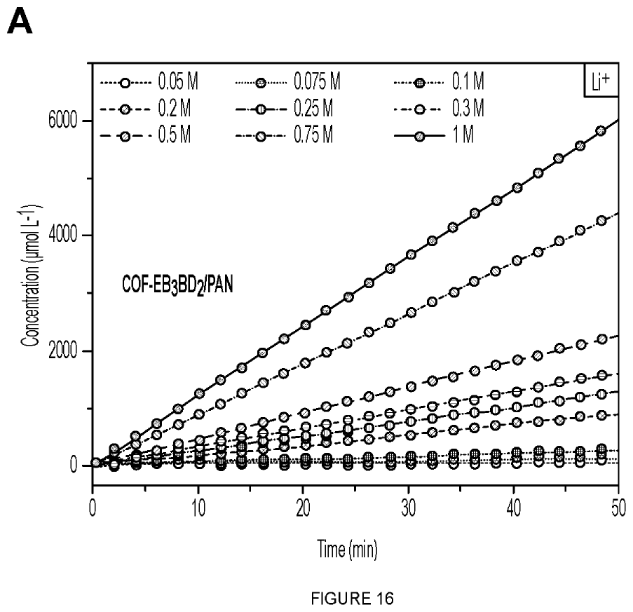

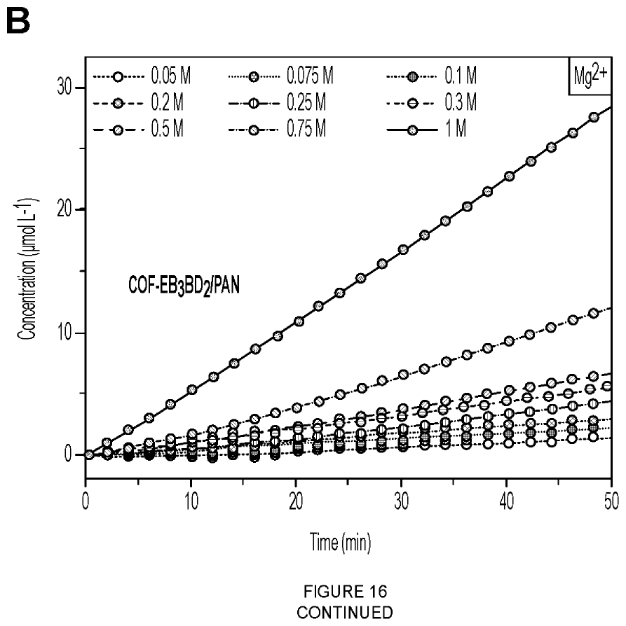

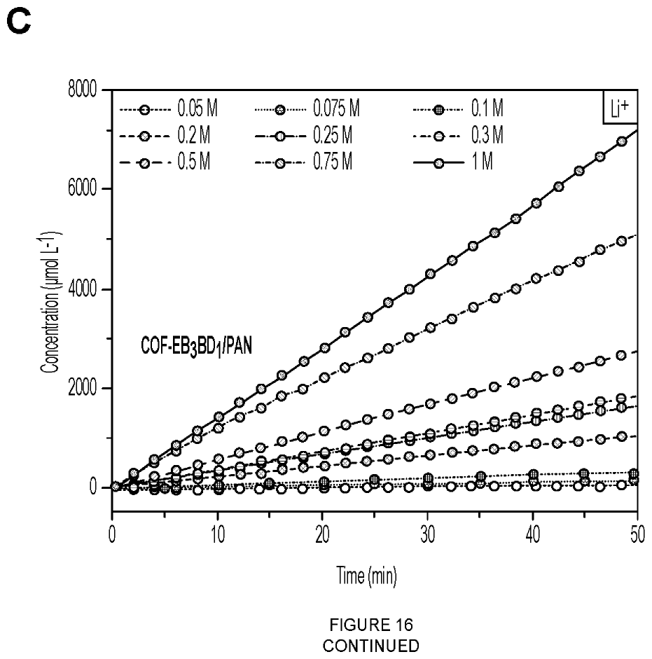

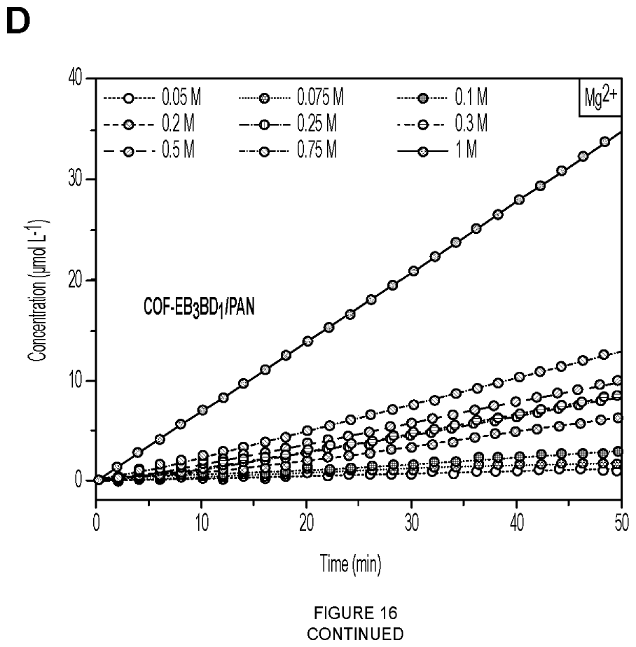

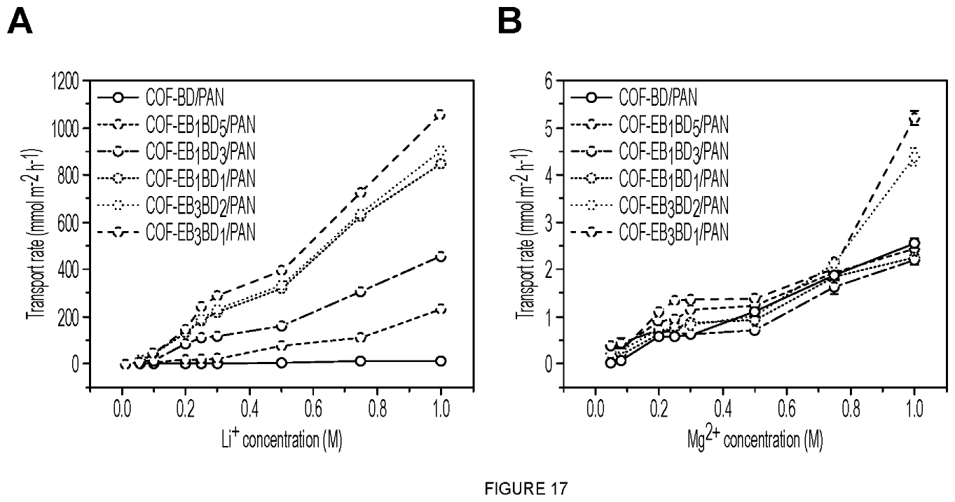

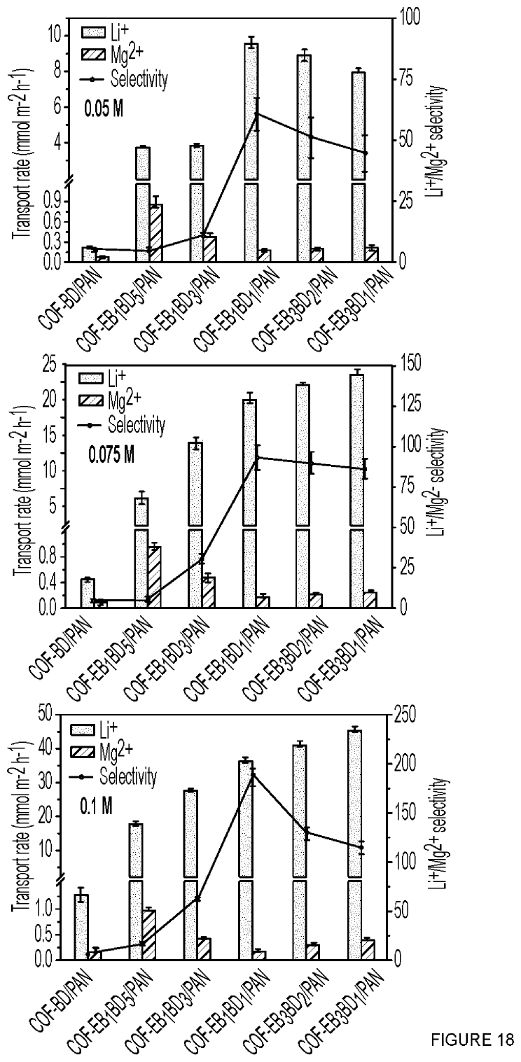

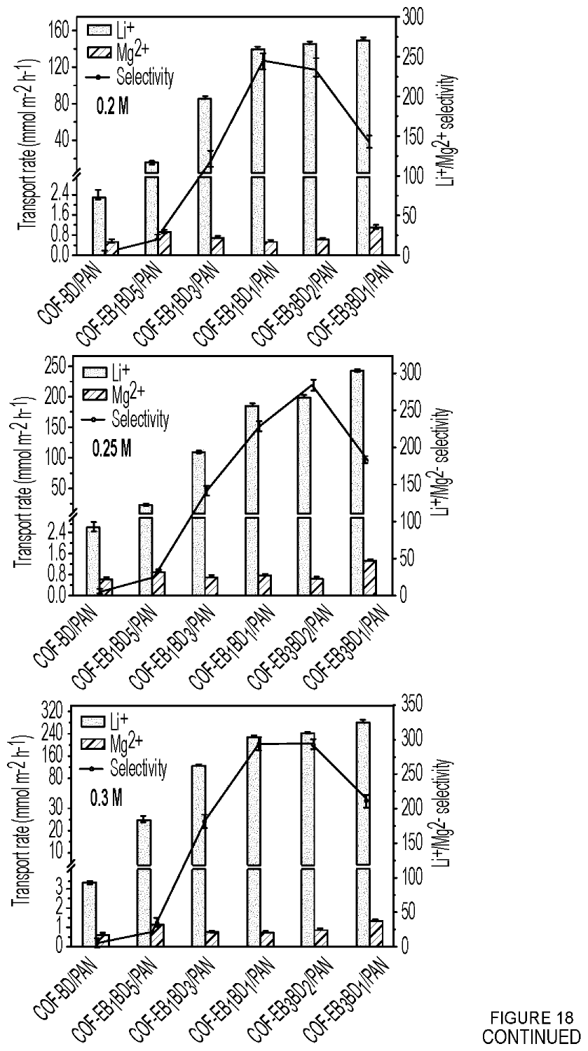

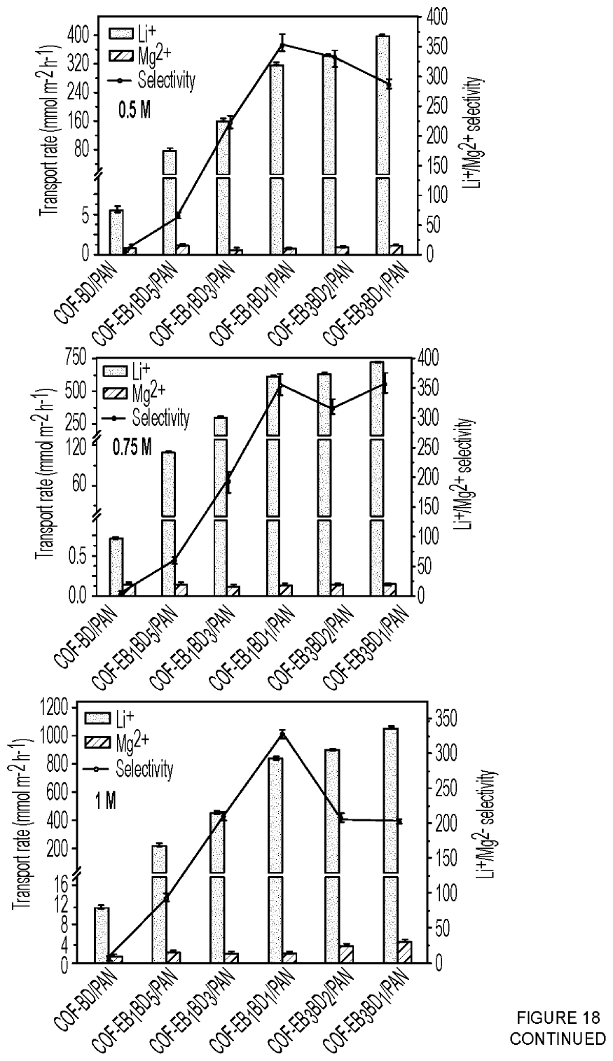

To further explore the relationship between the membrane charge density and apparent mass transport for Li⁺ and Mg²⁺ ions that traverse the membranes under various feed concentration conditions, the ion transport profiles of each COF membrane were plotted against the operation time (FIGS. 14A-14D, 15A-15D, and 16A-16D). All data points converged to reveal a linear relationship. FIGS. 17A-17B depict the feed solution concentration-profiled diffusion flux values. The transport patterns of Li⁺ and Mg²⁺ depending on the change in the ionic strength of the solution were similar to those of the membranes with different charge populations. Except for the neutral membrane, the ion transport rate was not proportional to the feed concentration, suggesting a crucial role of electrostatic interactions in ion transport. The Li⁺ ion diffusion rates for the COF-EBₓBD₁₋ₓ/PAN membranes were nearly linearly increased when the concentration of feed solution increased from 0.05 to 1.0 M. Conversely, the Mg²⁺ transport profile slightly increased when the salt concentration increased from 0.05 to 0.2 M, displayed a trend of smoothing when the salt concentration was in a range from 0.2 to 0.5 M, and then greatly increased when the salt concentration further increased from 0.5 to 1.0 M. Therefore, there is a dramatic rise in the Li⁺/Mg²⁺ separation factor from 60 to 353 upon increasing the salt concentration from 0.05 to 0.5 M, which reveals that variations in the ion concentration produce significant changes in the membrane selectivity (FIG. 18).

The transmembrane activities of other cations was examined. Given the superior performance of COF-EB₁BD₁/PAN, it was chosen for further studies, which revealed the preferred monovalent cation transport over that of divalent cations. Specifically, the separation factors for H⁺/Mg²⁺, Na⁺/Mg²⁺, Li⁺/Mg²⁺, and Ca²⁺/Mg²⁺ were 3094, 360, 353, and 0.62, respectively, under electrolyte concentrations of 0.5 M. These results can be rationalized by the mobility for the cation ions, following the trend of H⁺>Na⁺>Li⁺>Mg²⁺>Ca²⁺.

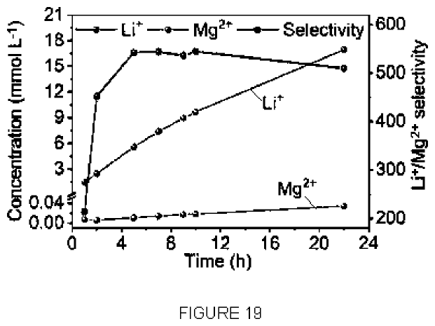

These results demonstrate that these membranes can be used for Li⁺ extraction from salt lakes. According to the established corrections between the salt concentration and Li⁺/Mg²⁺ separation factor, an equimolar binary mixture of LiCl and MgCl₂ (0.5 M each) was applied to test the separation performance of COF-EB₁BD₁/PAN. To obtain critical mechanistic insight, the kinetics of ion permeation through these membranes was monitored as a function of time (FIG. 19). As expected, the concentrations of Li⁺ and Mg²⁺ in the permeate increased linearly with time. The comparison of flux and selectivity between single and binary salt mixture measurements over the COF-EB₁BD₁/PAN membranes showed that the fluxes of both Li⁺ and Mg²⁺ ions decreased under binary salt conditions. The greater decline of Mg²⁺ flux relative to Li⁺ ions resulted in higher binary Li⁺/Mg²⁺ selectivity, compared to the ideal selectivity (505 & 353), placing it among the top materials. The decreased flux was ascribed to the concentration polarization. This is probably due to the negative zeta potential of the membranes causing local accumulation of cations, resulting in lower solute permeance. The significant Li⁺/Mg²⁺ selectivity can most likely be attributed to the competition mechanism in which Li⁺ ions can more easily penetrate the positively charged pore channel than Mg²⁺, and once Li⁺ ions are present in the channel, Mg²⁺ ions are excluded.

The outstanding separation performance under high ionic strength conditions makes COF-EB₁BD₁/PAN promising for extracting lithium from salt lakes. To evaluate the lithium and magnesium separation performance in the real system, an artificial brine with a mass ratio of magnesium (29.9 g L⁻¹) and lithium (0.85 g L⁻¹) of approximately 35 was prepared. This ratio was approximately 28.1/1 (mole ratio of Li⁺/Mg²⁺) in the second permeate chamber after a single pass through COF-EB₁BD₁/PAN, approaching the battery-grade purity.

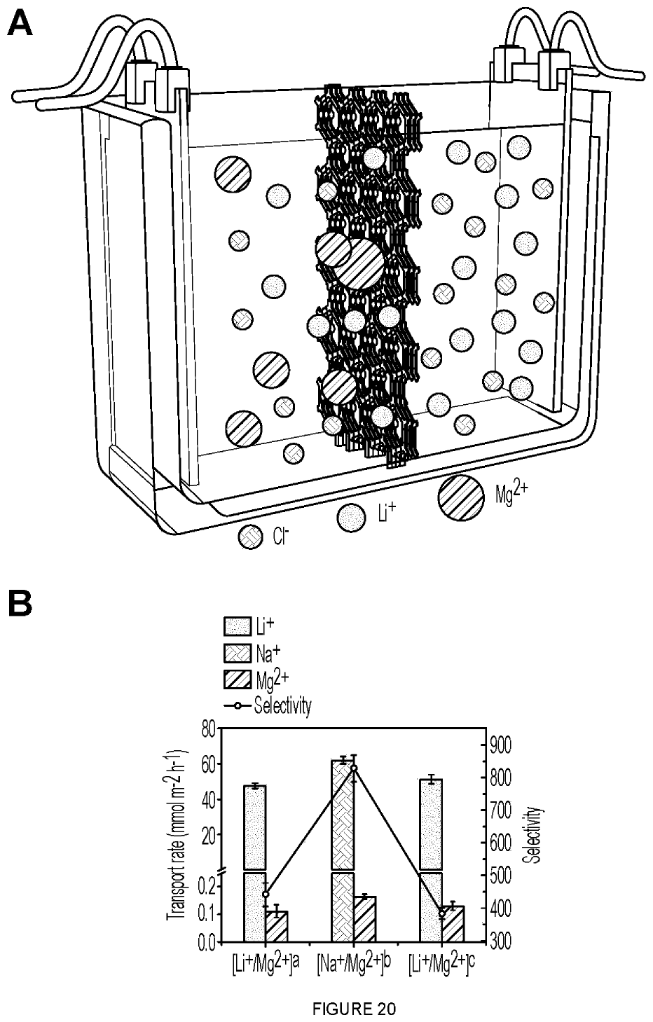

To explore the potential of COF-EB₁BD₁/PAN in practical operation, electrodialysis was conducted for Li⁺/Mg²⁺ separation using a setup relevant to the industry (FIGS. 20A-20B). Excellent permselectibity was achieved with Li⁺/Mg²⁺ and Na⁺/Mg²⁺ separation factors of 443 and 827, respectively, for the 1:1 binary solution (0.1 M each) at a current density of 0.5 mA cm⁻². Accordingly, the mole ratio of Li⁺/Mg²⁺ in the simulated Yiliping brine (Qinghai province in China with magnesium and lithium concentrations of 0.83 mol L⁻¹ and 0.031 mol L⁻¹, respectively) significantly increased from 0.0377 to 385 after electrodialysis. In addition to the separation factor, long-term stability is another essential criterion for practical applications. Negligible loss in permeability and selectivity was observed for COF-EB₁BD₁/PAN after continuous operations under electrodialysis conditions for 10 h as well as 2 months under various dialysis conditions. The comprehensive stability under various harsh conditions makes COF-EB₁BD₁/PAN a promising candidate for practical lithium extraction.

Materials and Measurements—Commercially available reagents were purchased in high purity and used without further purification. Triformylphloroglucinol (Tp), ethidium bromide (EB), and benzidine (BD were purchased from Jilin Chinese Academy of Sciences-Yanshen Technology Co., Ltd. The asymmetric polyacrylonitrile (PAN) ultrafiltration membrane was obtained from Sepro Membranes Inc. (Carlsbad, CA, USA) with a molecular weight cut off of 40,000 Da. X-ray powder diffraction (XRD) patterns were measured with a Rigaku Ultimate VI X-ray diffractometer (40 kV, 40 mA) using CuKα (λ=1.5406 Å) radiation. Scanning electron microscopy (SEM) was performed on a Hitachi SU 8000. FT-IR spectra were recorded on a Nicolet Impact 410 FTIR spectrometer. X-ray photoelectron spectroscopy (XPS) spectra were performed on a Thermo ESCALAB 250 with Al Kα irradiation at θ=90° for X-ray sources, and the binding energies were calibrated using the C1s peak at 284.9 eV.

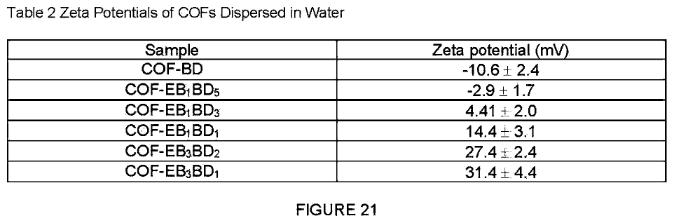

Membrane Syntheses—COF-BD/PAN. COF active layers were formed via interface polymerization on the surface of an asymmetric polyacrylonitrile (PAN) ultrafiltration membrane. The PAN support was vertically placed in the middle of a homemade diffusion cell, resulting in each volume of 7 cm³ (FIG. 21). An aqueous solution of benzidine (BD, 15.2 mg, 0.083 mmol) and p-toluenesulfonic acid (TsOH, 31.5 mg, 0.165 mmol) (7 mL), and the CH₂Cl₂ solution (7 mL) of triformylphloroglucinol (Tp, 11.6 mg, 0.055 mmol) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB₁BD₅/PAN—The PAN support was vertically placed in the middle of a homemade diffusion cell, resulting in each volume of 7 cm³. An aqueous solution (7 mL) of BD (12.7 mg, 0.069 mmol), ethidium bromide (EB, 5.4 mg, 0.014 mmol), and TsOH (31.5 mg, 0.165 mmol), and the CH₂Cl₂ solution (7 mL) of Tp (11.6 mg, 0.055 mmol) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB₁BD₃/PAN—The PAN support was vertically placed in the middle of a homemade diffusion cell, resulting in each volume of 7 cm³. An aqueous solution (7 mL) of BD (11.4 mg, 0.062 mmol), ethidium bromide (EB, 8.2 mg, 0.021 mmol), and TsOH (31.5 mg, 0.165 mmol), and the CH₂Cl₂ solution (7 mL) of Tp (11.6 mg, 0.055) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB²BD³/PAN—The PAN support was vertically placed in the middle of a homemade diffusion cell, resulting in each volume of 7 cm³. An aqueous solution (7 mL) of BD (9.1 mg, 0.049 mmol), ethidium bromide (EB, 13.1 mg, 0.033 mmol), and TsOH (31.5 mg, 0.165 mmol), and the CH₂Cl₂ solution (7 mL) of Tp (11.6 mg, 0.055) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB₁BD₁/PAN—The PAN support was vertically placed in the middle of a homemade diffusion cell, resulting in each volume of 7 cm³. An aqueous solution (7 mL) of BD (7.6 mg, 0.041 mmol), ethidium bromide (EB, 16.3 mg, 0.041 mmol), and TsOH (31.5 mg, 0.165 mmol), and the CH2Cl2 solution (7 mL) of Tp (11.6 mg, 0.055) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB₃BD₂/PAN—The PAN support was vertically placed in the middle of a homemade diffusion cell, resulting in each volume of 7 cm³. An aqueous solution (7 mL) of BD (6.1 mg, 0.033 mmol), ethidium bromide (EB, 19.6 mg, 0.049 mmol), and TsOH (31.5 mg, 0.165 mmol), and the CH₂Cl₂ solution (7 mL) of Tp (11.6 mg, 0.055) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

COF-EB₃BD₁/PAN—The PAN support was vertically placed in the middle of a homemade diffusion cell, resulting in each volume of 7 cm³. An aqueous solution (7 mL) of BD (3.8 mg, 0.021 mmol), ethidium bromide (EB, 24.4 mg, 0.062 mmol), and TsOH (31.5 mg, 0.165 mmol), and the CH2Cl2 solution (7 mL) of Tp (11.6 mg, 0.055) were separately introduced into the two sides of the diffusion cell. The reaction mixture was kept at 30° C. for 4 days. The resulting membrane was rinsed with methanol to remove any residual monomers and catalyst. Finally, each membrane was rinsed with water for 24 h and then used for permeation tests or air-dried for physicochemical characterization.

Free-Standing COF-EbₓBD_{y} Membranes—A vial (25 mL) was charged with CH₂Cl₂ solution of Tp. An aqueous solution of BD, ethidium bromide and TsOH was gently placed on the top of the DCM phase. The amounts of the involved chemicals are the same as that used for growing membrane on PAN. The reaction mixture was kept at 30° C. for 4 days. The resulting membrane was washed with methanol using Soxhlet extraction for 2 days to remove any residual monomers and catalyst.

Dye Molecule Exclusion Experiments—To experimentally evaluate the size of defects in the membranes, dye molecule exclusion experiments were performed. Methyl blue was the dye of choice as its size slightly larger than the pore size of the COFs. Permeation tests were conducted using a dead-end stirred cell at room temperature. 20 ppm of methyl blue aqueous solution was used as a feed solution. The water permeation amounts were measured gravimetrically using a balance, and experiments were performed at a pressure of 3 bar. The water permeabilities are in the range of 0.23-0.37 L m⁻² h⁻¹ bar⁻¹, and no dye molecules were detected in the permeate solutions, as indicated by UV-Vis results. The low water permeability and high dye rejection efficiency suggest that the size of defects, if any, in the membranes is smaller or comparable to that of the intrinsic COF porosity (2 nm).

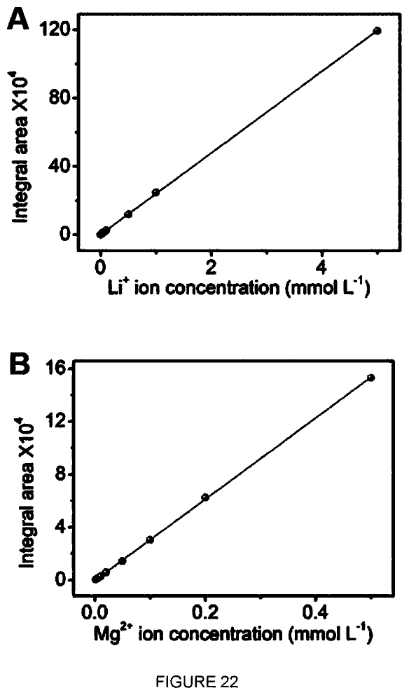

Dialysis Experiments—Ion diffusion tests were carried out using a homemade diffusion cell. Membrane samples were sandwiched between two polydimethylsiloxane O-rings and sealed in the middle of the cells using clips, and the COF layers were set to face the feed solution. The effective area of the membrane samples in the cell was 3.14 cm². In single-salt dialysis diffusion tests, 25 mL of salt solution (LiCl and MgCl₂) was used as the feed solution, and the permeate side was filled with 25 mL of deionized water. The ion concentration of the permeate solution was recorded using a conductivity meter. The transport kinetics were reflected in the linear slope in the plot of ion concentration in the permeate chamber versus operation time. In binary ion diffusion tests, 28 mL of a salt solution containing equimolar concentration of LiCl and MgCl₂ was used as the feed solution, and the permeate side was filled with 28 mL of deionized water. The concentrations of Li⁺ and Mg²⁺ in the permeate side were measured by ion chromatography. The concentration change of the permeate solution over time was obtained based on the linear relationship between the surface area and concentration of salt solutions (FIGS. 22A-22B). A series of salt solutions with various concentrations were prepared, and their surface areas measured by ion chromatography to derive the calibration curves. For membrane recycling, the used membrane was washed with deionized water on the diffusion cell for 12 h. This procedure was carried out twice more before used for the next run.

Permselectivity Evaluation—For investigating the lithium and magnesium transport property across COF-EBₓBD_{y}/PAN, the ion current was recorded by CHI660E with a homemade electrochemical cell. The voltage was scanned with a step of 0.01 V s-1 using Ag/AgCl electrodes. Given the unidentical same ion permeability from the two sides of the membrane, the Li⁺ and Mg²⁺ transmembrane activity relative to Ca²⁺ was evaluated. The Li⁺/Mg²⁺ selectivity of COF-EBₓBD_{y}/PAN was calculated by determining the reversal potentials whereby 0.1 M LiCl or 0.05 M MgCl₂ was filled in the cis side, facing COF layer, and 0.05 M CaCl₂ was filled in the trans side. The X-intercepts (Vr) of the I-V plots represent the average reversal potentials. The relative permselectivity was determined according to the Goldman-Hodgin-Katz equation.

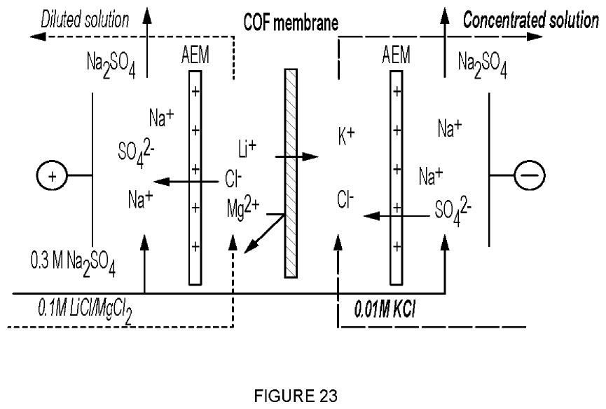

Electrodialysis Experiments—Electrodialysis experiments were performed at a current density of 0.5 mA cm². As shown in FIG. 23, the COF active layer was faced to the anode. A 200 mL solution of 0.3 M Na₂SO₄ was used to circulate in the electrode compartments. The diluted chamber contained 200 mL 0.1 M LiCl/MgCl₂ solution and the concentrated chamber was filled with 200 mL 0.01 MKCl solution. All solutions were circulated by peristaltic pumps at a flow rate of 15 mL min⁻¹. The experiments lasted for 1 h, and the concentrations of Li⁺ and Mg²⁺ in the concentrated chamber were analyzed by IC. The corresponding flux through the membrane was calculated from the concentration change in the concentrated chamber according to Equation 1 below:

$$J = \frac{( {C}_{t} - {C}_{0} ) \cdot V}{{A}_{m} \cdot t} \qquad Equation 1$$

where J (mol cm⁻² s⁻¹) is the ion flux, Cₜ (mol L⁻¹), C₀ (mol L⁻¹) represent the ion concentration at time 0 and t, respectively. V (m³) is the volume of circulated solution in the concentrated compartment. The perm-selectivity

$$( {P}_{{Mg}^{2 +}}^{{Li}^{+}} )$$

between Li⁺ and Mg²⁺ was calculated using Equation 2 below:

$${P}_{{Mg}^{2 +}}^{{Li}^{+}} = \frac{{J}_{{Li}^{+}} \cdot {C}_{{Mg}^{2 +}}}{{J}_{{Mg}^{2 +}} \cdot {C}_{{Li}^{+}}} \qquad Equation 2$$

where C_{Mg}_{²⁺} (mol L⁻¹), C_{Li}_{⁺} (mol L⁻¹) are average concentrations of Mg²⁺ and Li⁺ in the diluted chamber during experiment.

The high intrinsic modularity of COFs allows for precise compositional tuning for the optimization of a membrane's ion-transport activity. By identifying parameters that are critical to ion-transport, the inventors have discovered a means by which the separation performance of membranes can be improved. The inventors have shown that charge site distribution can be tuned by systematically introducing ionic functionality and used to control the transport profile of ions with different valences. Aspects described herein provide critical mechanistic insights into ion transport at the nanoscale and a rational approach for optimizing membrane performance, with implications for achieving a greater understanding of the functions of ion channels in cell membranes, which ultimately enhances the development of membrane science.

### 2. COF-4EO-PAN Membrane Fabrication and Characterization

In addition to tuning membrane selectivity by modifying ionic functionality, the inventors have also discovered that incorporating lithiophilic oligoethers functional groups into COF membrane structures conferred specificity and facilitated the diffusion of lithium along the pore pathway. The ion channel characteristics were confirmed by reversal potential measurements, which showed that the relative permeability decreased in the order of Li⁺>K⁺>Na⁺>Ca²⁺>Mg²⁺. The Li⁺ ion transfer was enhanced while other ions were obstructed, allowing for high selectivity as well as permeability. A Li⁺/Mg²⁺ separation factor of up to 64 was achieved, indicating high lithium affinity. These results provide the basis for developing selective artificial membranes for effective ion separation.

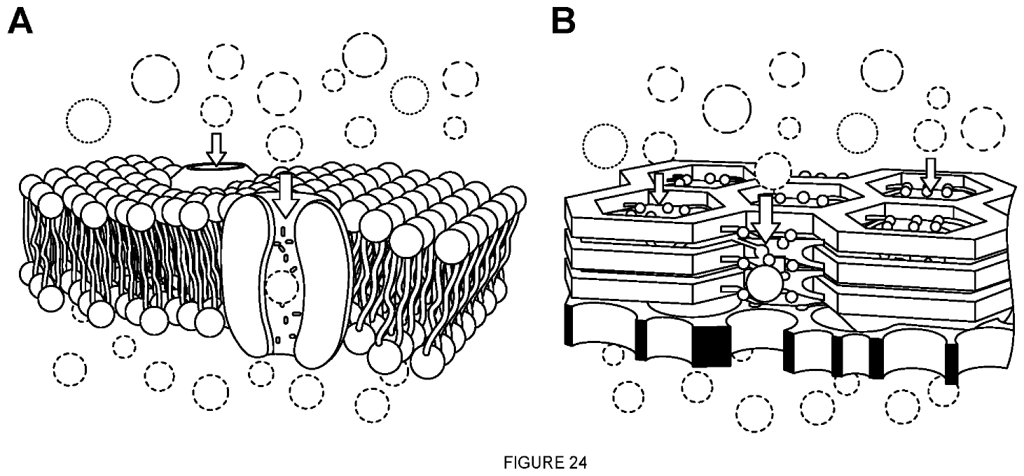

State-of-the-art positively charged nanofiltration membranes show a satisfactory Li⁺/Mg²⁺ separation factor of up to 10, a critical requirement for achieving high-grade Li₂CO₃. To develop new synthetic Li⁺ transporters, membranes with lithiophilic functionality were investigated in order assess lithium selectivity. Specifically, porous membranes based on two-dimensional covalent organic frameworks (COFs) functionalized with polyethylene oxide (PEO) moieties were examined for their ability to coordinate and transport Li⁺. In contrast to the current nanofiltration membranes which are optimized empirically, COFs with the advantage of high modularity can potentially form active layers with artistic pore structures and tunable functionality. Further, the discogens of 2D COFs are arranged in a columnar fashion, owing to the strong π-π interactions between aromatic cores and the aligned lithiophilic functionalities orientated in close proximity, offering unidirectional pathways for swift ion diffusion and enhanced communication between adjacent ions in the queue (FIGS. 24A-24B).

COF-based membranes implanted with oligoethers provide an ion-diffusion pathway in which the transport of Li ions is accelerated by rapid and reversible coordination with the ether moieties, thereby differentiating Li⁺ ions from other ions. Theoretical and spectroscopic studies were carried out to explain the observed selective extraction efficiency based on the interaction and dynamic exchange between oligoethers and Li⁺ ions. The synergistic effect between the densely populated lithiophilic sites and the one-dimensional channels promotes significantly faster ion transport rates and allows the use of thicker films. The performance is very stable, as reflected by the fact that the selectivity is retained under the same conditions for at least 40 h. These studies indicate that pore environment engineering by introducing lithiophilic functionalities is a promising strategy to optimize the separation performance of membranes that circumvent the issues of current ones that require trade-offs in properties.

1,3,5-tris-(4-aminophenyl)benzene (TAB) was selected as the base for the construction of COF membranes because the resulting COFs have not only been proven to be stable under a wide range of conditions, but also possess high crystallinity as well as geometrical compatibility with various aldehydes. To construct lithium channels, TAB was paired with an aldehyde monomer bearing oligo (ethylene oxide) chains, 2,5-bis (2-(2-(2-methoxyethoxy)ethoxy)ethoxy)terephthalaldehyde (4EO). In each polyethylene oxide-Li complex, there are four ether oxygens coordinated to each Li⁺ ion. To reveal the role of oligoether moieties and exclude the impact of channel congestion resulting from the introduced substituted group, TAB was also paired with 2,5-bis(heptyloxy)terephthalaldehyde (OHep) for comparison.

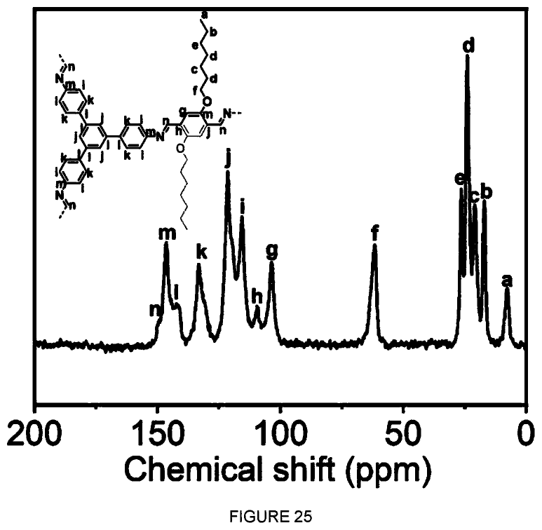

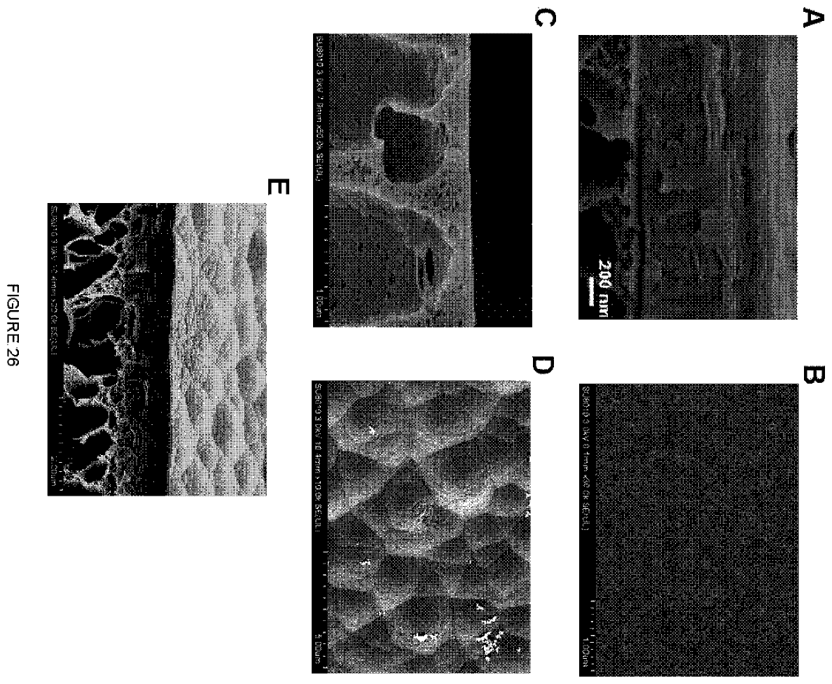

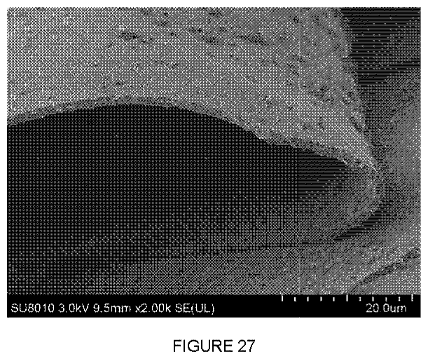

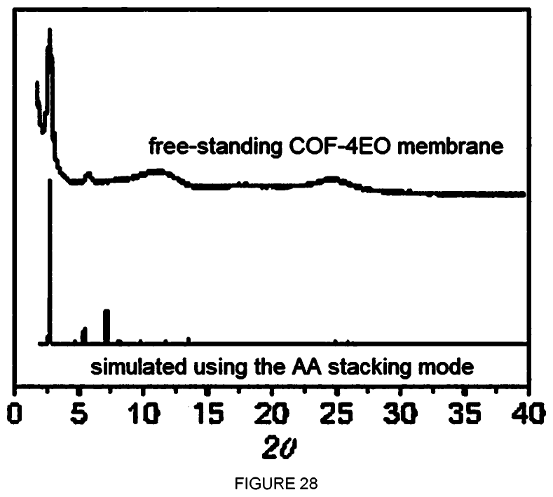

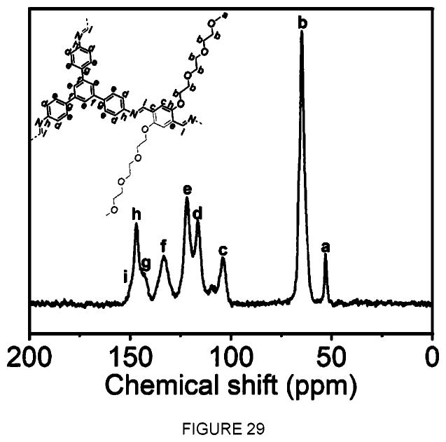

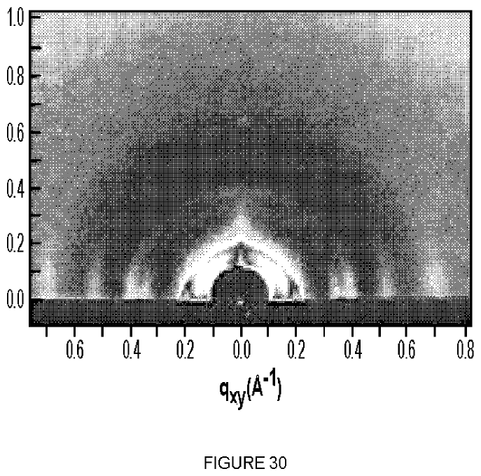

The morphologies of the as-prepared COF-4EO-PAN were examined by scanning electron microscopy (SEM). Compared with the pristine PAN, the SEM images of COF-4EO-PAN showed several notable features (FIG. 25). Cross-sectional SEM images of pristine PAN and COF membranes revealed distinct regions with different morphologies. COF-4EO-PAN was composed of multiple nanosheets, which were stacked layer-by-layer into a highly regular and lamellar structure with a thickness of approximately 1 μm (FIG. 26A-26E). The top view of the SEM image of COF-4EO-PAN revealed that the PAN support was completely covered with a layer of COF material. The Fourier-transform infrared (FT-IR) spectra of both the TAB and BTA monomers, and the free-standing COF membrane, which was achieved by dissolving the PAN support in dimethylformamide (DMF), are shown in FIG. 26D and FIG. 26E. In contrast to the spectra of TAB and BTA, no peaks were observed in the primary amine region (3440 and 3350 cm⁻¹) and at 1685 cm⁻¹, corresponding to the carbonyl group, in the spectrum of the COF membrane. Together with the appearance of the characteristic C=N band at 1614 cm⁻¹, this suggests the formation of a COF layer, and that no detectable monomers are trapped in the membrane (FIG. 27). Moreover, the peak ascribed to the aldehyde group at around 170 ppm disappeared in the solid-state ¹³C nuclear magnetic resonance spectrum of the free-standing COF-4EO membrane, further supporting the aforementioned claim. The powder X-ray diffraction (PXRD) pattern of the free-standing COF membrane showed several prominent diffraction peaks suggestive of its high crystallinity (FIG. 28). To determine the structure, Materials Studio was used to reveal that the experimental powder patterns were well matched with the optimized p6m symmetric structure model in eclipsed AA stacking. The porosity of the membrane was evaluated by N₂ sorption isotherms, showing that COF-4EO processed a Brunauer-Emmett-Teller surface area of 837 m² g⁻¹ and a pore size of 2.34 nm (FIG. 29). To gain insight into the extent of alignment of the COF layer on PAN, grazing-incidence wide-angle X-ray scattering (GIWAXS) measurements were performed, which indicated that COF-4EO-PAN had a (001) direction perpendicular to the substrate (FIG. 30). Therefore, a COF active layer with its 2D plane flat on the substrate was successfully prepared, with the oligo (ethylene oxide) chains vertically lining the pore walls.

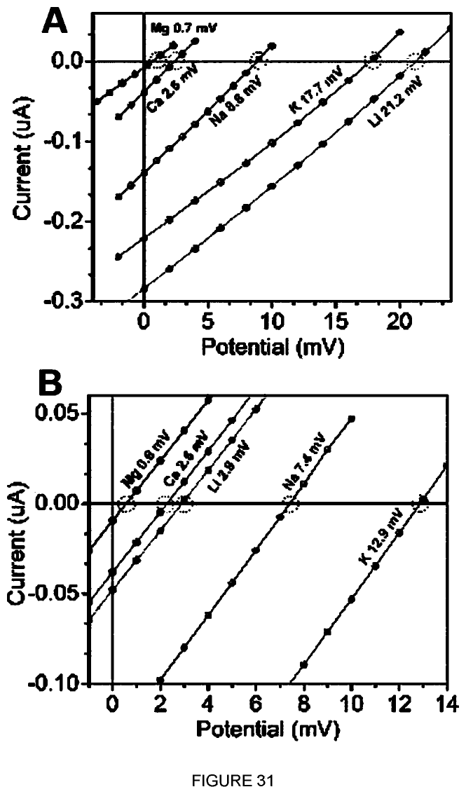

Ion Transport Characterization—To demonstrate the ion channel characteristics of the resulting membranes, the relative permeability of various ions was investigated by measuring the reversal potentials. Tests were carried out on a bi-ionic system separated by the COF membranes. MgCl₂ solution was introduced on the trans side, and various metal chlorides, such as NaCl, KCl, LiCl, MgCl₂, or CaCl₂, were placed on the cis side (facing COF layer). To evaluate the relative permeability of cations exclusively, the concentrations of Cl ions were kept the same. From the x-intercepts of the current traces plotted against voltages, the reversal potentials were obtained. When the cis side was filled with MgCl₂, the resulting current-voltage (I-V) curves almost passed through the origin, suggesting that both COF-4EO-PAN and COF-OHep-PAN showed almost equal permeabilities on both sides. Reversal potentials of 21.2 mV, 17.7 mV, 8.8 mV, and 2.5 mV were observed for LiCl, KCl, NaCl, and CaCl₂, respectively, indicating a higher permeability of Li⁺ over other cations (FIG. 31A). In contrast, COF-OHep-PAN exhibited an ion transport selectivity trend of K+>Na⁺>Li⁺>Mg²⁺>Ca²⁺, in agreement with their intrinsic ion transmission efficiency (FIG. 31B). These results verified the high activity of the oligoether-mediated transport of Li⁺ ions.

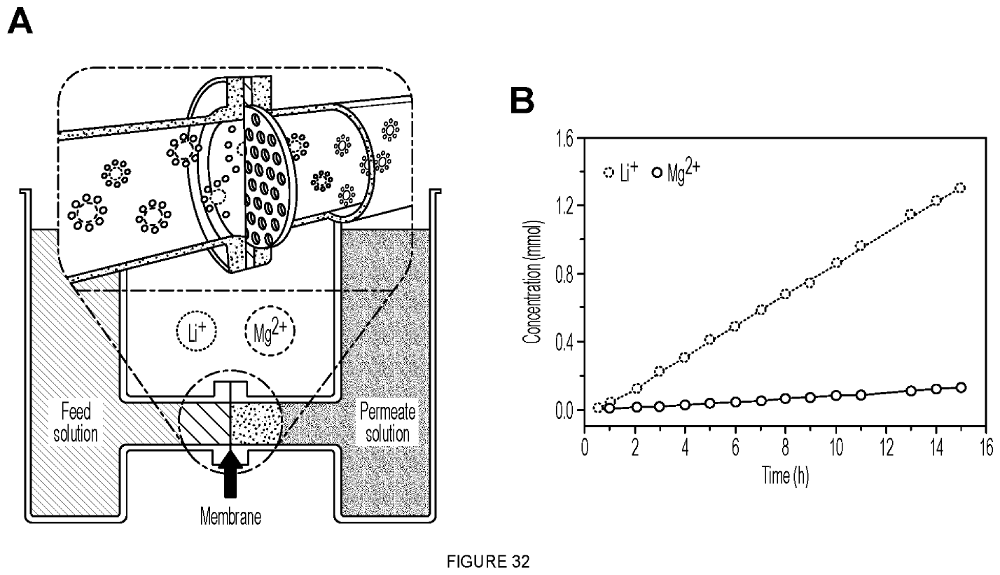

To investigate the separation of lithium and magnesium, ion transport kinetics measurements were conducted to further demonstrate the ability of COF-4EO-PAN to selectively transport Li⁺ over Mg²⁺ across the membrane. The experiments were conducted at room temperature using a homemade diffusion cell, wherein the feed and permeate chambers were filled with an aqueous salt solution and deionized water, respectively (FIG. 32A). The ion concentration in the permeate chamber was analyzed at different time intervals by ion chromatography, with each point measured three times in parallel. As shown in FIG. 32B, the concentrations of both Li⁺ and Mg²⁺ ions increase linearly over time, and the slope for Li⁺ is much steeper than that of Mg²⁺, indicative of the higher permeability of Li⁺ over Mg²⁺ across the membrane. A Li⁺/Mg²⁺ separation factor of 12 was obtained by dividing the slopes. In contrast, COF-OHep-PAN afforded a Li⁺/Mg²⁺ separation factor of only 3 under otherwise identical conditions.

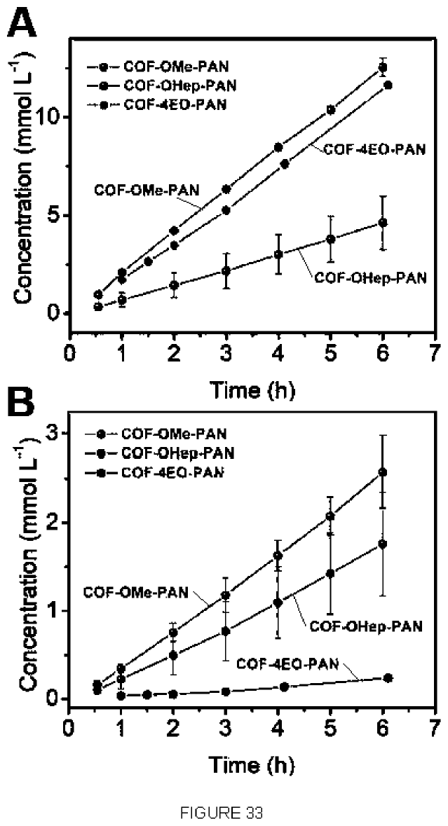

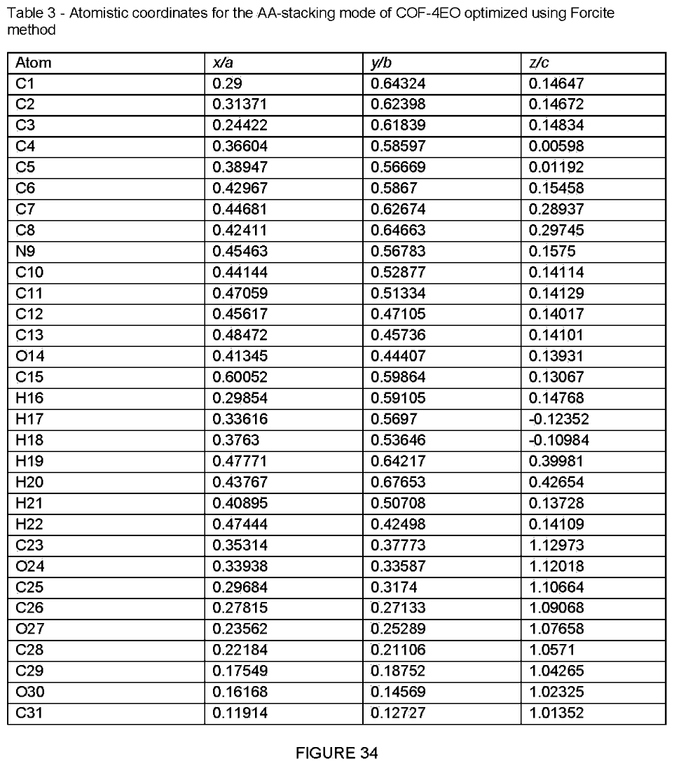

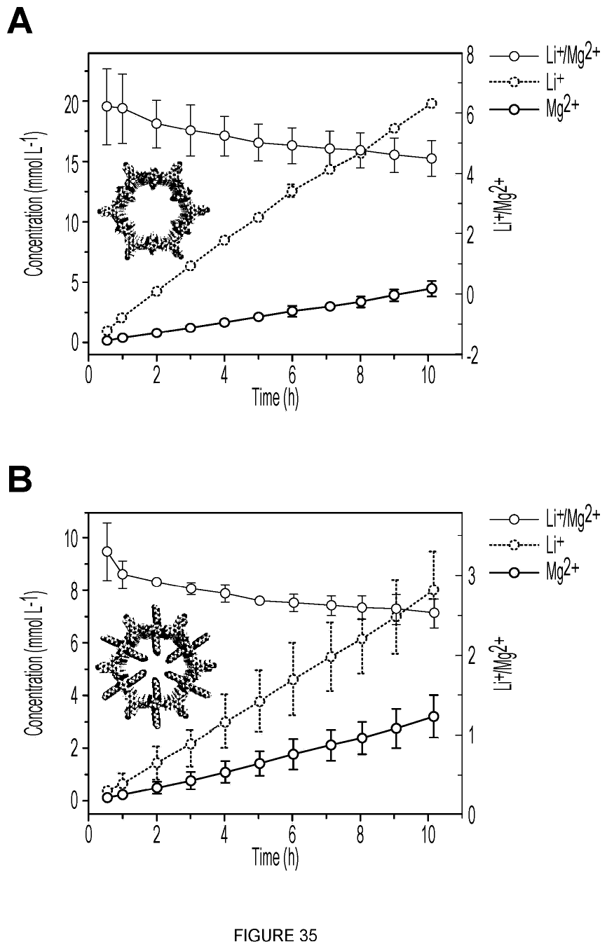

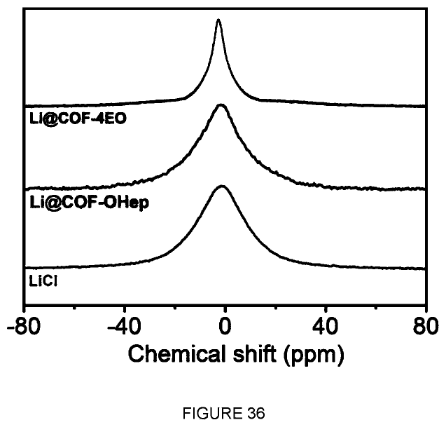

To understand the chemical basis of the binding selectivity of COF-4EO-PAN toward Li⁺ over Mg²⁺, quantum density functional theory (DFT) computations were performed. Calculations of the truncated fragments shown in FIGS. 33A-33B were performed using M062X exchange and correlation functions, and a 6-311G* basis was used for all atoms. The binding free energies for Li⁺ and Mg²⁺ to the oligoether were computed using the quasi-chemical method, and showed that the oligoether moiety exhibits a higher binding affinity toward Li⁺ over Mg²⁺ by 55.5 kJ mol⁻¹ in aqueous solution (FIG. 34). X-ray photoelectron spectroscopy (XPS) was performed to analyze the interaction between Li⁺ and the oligoethers. The binding energy of lithium species in Li⁺@COF-4EO (55.9 eV) is lower than that in LiCl (56.6 eV), reflecting the electron transfer from the ethylene oxide moiety to the Li ions (FIGS. 35A-35B). To further understand the Li⁺ transport processes in COF-4EO-PAN, the dynamic behavior of Li ions in the COF channels was studied by static solid-state ⁷Li nuclear magnetic resonance spectroscopy (NMR). Spectra of LiCI and Li@COF-OHep (COF-OHep is the corresponding powder form of COF-OHep-PAN) were collected as references to show the spectroscopic behavior of Li species in a solid matrix with minimal mobility, and in porous material with no lithium binding sites, which gave rise to very broad peaks centered at −1.53 ppm. By contrast, a narrower ⁷Li NMR signal was detected for COF-4EO, suggestive of the weakened solid-state couplings, and hence the higher mobility (FIG. 36).

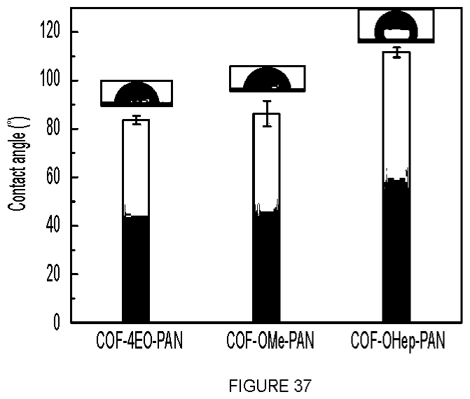

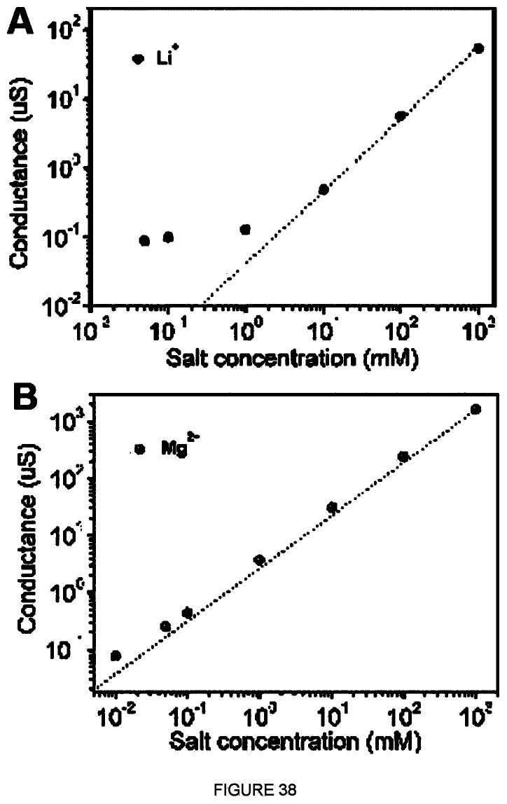

Based upon the characterization data, oxygen atoms in the oligoether moieties appear to replace oxygen atoms in water and coordinate with the Li⁺ ion. The oligoether moieties thus act like surrogate water with the energetic costs of dehydration balanced by the energy gains from coordination with oxygen atoms. This process may be further facilitated by the hydrophobic COF active layer, as revealed by the contact angle measurements (FIG. 37). The alkyl chain exhibited no specific affinity for Li⁺ ions, thus giving rise to an inferior selective permeation. However, the mechanism of the conduction of Li⁺ ions through the COF channels was still unclear as the characterization results implied that a single Li ion would be held very tightly within the membrane. To understand this, the Li⁺ concentration was evaluated in COF-4EO-PAN by measuring the transmembrane ionic conductance. The membrane was squeezed between two reservoirs containing symmetric salt solutions of various concentrations. The measured ionic conductance deviated from the bulk values, suggesting that the Li⁺ ions are enriched in the pore channels (FIG. 38A). The high concentration of the densely coordinated Li⁺ ions in the pore channel results in mutual repulsion, which overcomes the otherwise strong interaction between the oligoether and Li⁺ ion, thereby promoting the transport of Li⁺ along the direction of the concentration gradient. The transmembrane ionic conductance of Mg²⁺ was close to that of the bulk electrolyte solution, confirming the ability of COF-4EO-PAN to facilitate the transport of Li⁺ ions (FIG. 38B). Strong interactions between Li⁺ ions and the lithiophilic oligoether arms, as well as a high throughput mediated by concentration gradient-driven transport were therefore confirmed. A tentative transport mechanism was proposed: the rapid and reversible complexation between the oligoether moiety and Li⁺ together with the dynamic environment created by the aligned oligoether chains, which allows the ions to move from one binding site to the next, selectively augments the transport of Li ions through the membrane.

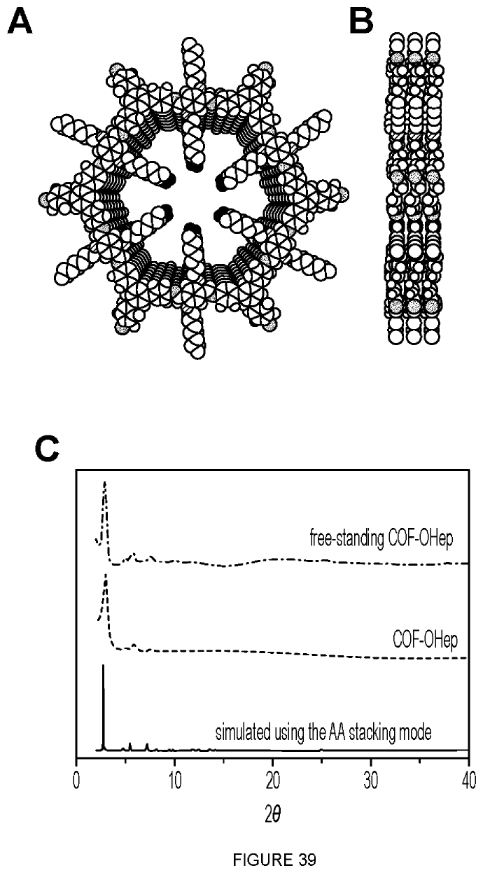

After confirming the role of the aligned oligoethers on conferring ion selectivity, their impact on the ion transport activity was investigated. Even with COF-4EO-PAN having much-crowded pore channels than COF-OMe-PAN (there is only one methoxyl group branching off the phenyl ring, FIGS. 39A-39C), both afforded comparable Li-ion transport rates, which were much faster than that of COF-OHep-PAN. In contrast to the Li⁺ ions, the permeation of Mg²⁺ ions is in good accordance with the free space of the pore channels, decreasing in the order COF-OMe-PAN>COF-OHep-PAN>COF-4EO-PAN, with more extended substitution groups giving a lower flux. These results confirm that lithiophilic oligoethers facilitate the transport of Li⁺ ions , but obstruct the Mg²⁺ ions from moving through the membrane channels. Given their comparable thickness and pore structure, the significant disparity in Li⁺/Mg²⁺ selectivity between COF-4EO-PAN and COF-OHep-PAN appears to originate from the densely populated lithiophilic arms in COF-4EO-PAN, which could arrange into a transport pathway, allowing the diffusion of Li⁺ ions, reminiscent of that seen in cellular membranes.

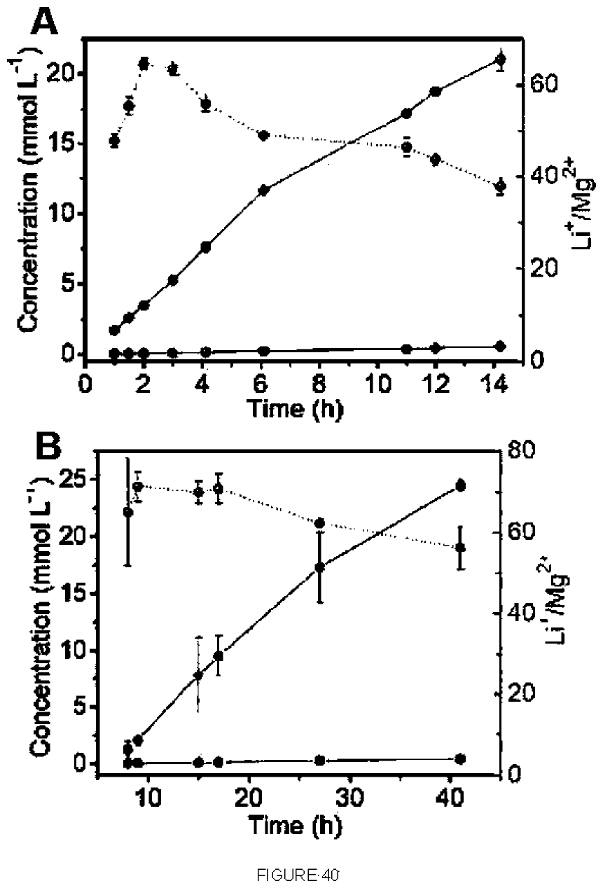

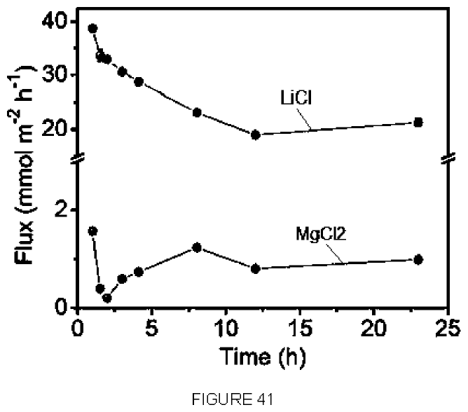

The lithium extraction efficiency of COF-4EO-PAN was examined using a mixture of LiCl (0.1 M) and MgCl² (0.1 M) aqueous solutions. FIG. 40A shows the selectivity profile and the concentrations of Li⁺ and Mg ions in the permeate solution as a function of time. The Li⁺ and Mg²⁺ concentrations increased with time. The Li⁺/Mg²⁺ ratio over COF-4EO-PAN increased during the initial 2 h, reaching its maximum value of 64, and then slightly decreased. The higher binary Li⁺/Mg²⁺ selectivity when compared to the ideal selectivity can be ascribed to the competitive coordination between the oligoether moiety and Li⁺ and Mg²⁺ ions. To better understand this process, the real-time fluxes of Li⁺ and Mg²⁺ ions were calculated. It was observed the flux of Li⁺ ions always much greater than that of Mg ions, validating the higher affinity of COF-4EO-PAN toward Li⁺ species (FIG. 41). The increased flux of Mg²⁺ after 2 h could be attributed to the tendency of permeation to reach equilibrium and concentration-dependent competing interactions with binding sites, thus resulting in decreased selectivity. The observed relatively lengthy induction period (2 h) may be a disadvantage during actual application, but offers the opportunity to manipulate performance combinations to match process scale requirements.

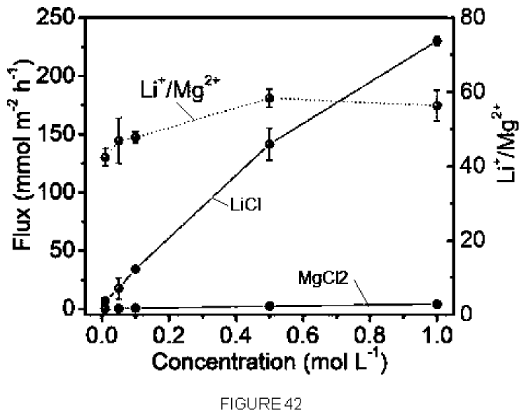

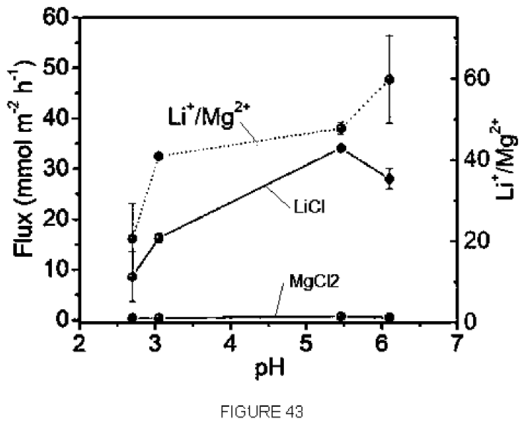

Given that the concentration gradient is the driving force of dialysis, an increase in feed concentration is expected to enhance permeability, and consequently, the efficiency. With the rise in the concentration of feed solution from 0.01 M to 1.0 M, the flux of Li⁺ through COF-4EO-PAN increased from 6.8 to 230 mmol m⁻² h⁻¹, while the selectivity was retained (FIG. 42). This offers an advantage over the state-of-the-art charge-modified membranes, where increasing the salinity usually results in partial or complete loss in selectivity. To further test the applicability of COF-4EO-PAN for lithium mining from various systems, the impact of solution pH on the Li⁺/Mg²⁺ separation performance was investigated. Considering that Li⁺ and Mg²⁺ species are inclined to precipitate out in the form of hydroxide, the lithium extraction performance under the pH values ranging from 2.5-6.1 were evaluated, which revealed that the separation factor increases along with the increase of solution pH (FIG. 43). This is because the ether oxygen species may be protonated under low pH conditions, thereby reducing the coordination ability of the oligoether moieties toward Li⁺.

The stability of COF-4EO-PAN was further assessed by evaluating its performance over multiple cycles, which is an essential feature of any system considered for use in industrial applications. A new feed solution and deionized water were used. A negligible decrease in selectivity and flux was observed after 5 cycles, providing evidence of the robustness of the membrane. Another major concern is that in low-grade salt lakes, the Mg²⁺ /Li⁺ ratio is up to 30. This could be addressed by connecting a number of permeate chambers in series. For example, with a feed solution having Mg²⁺ /Li⁺ ratio of 30, the ratio reached approximately 0.5 in the second permeate chamber. For practical applications, continuous dialysis is preferred over batch dialysis. To demonstrate the applicability of COF-4EO-PAN in continuous dialysis, the ratio of Li⁺/Mg²⁺ was tested cyclically. After testing for at least 40 h, only a slight decrease in selectivity was observed (FIG. 40B).

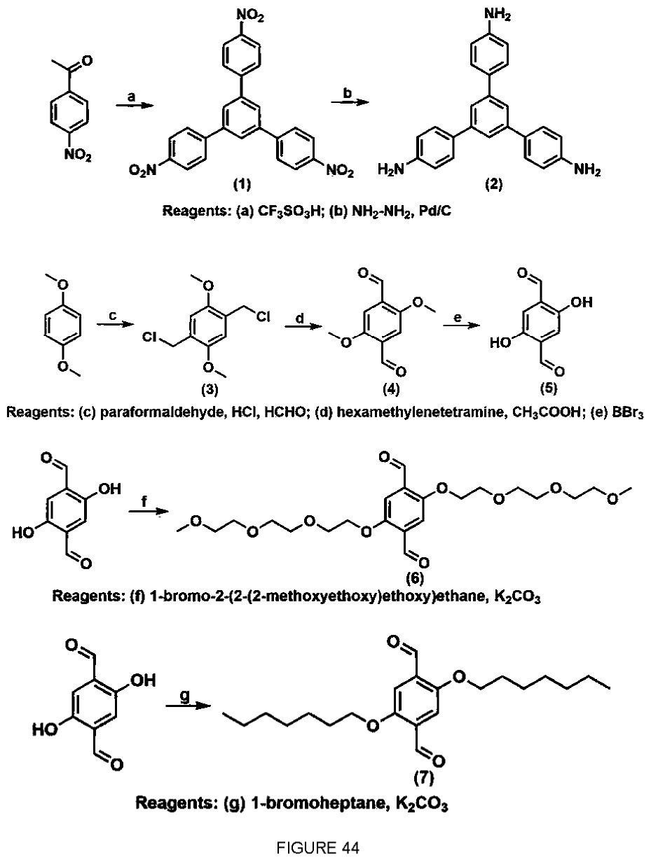

Synthesis of 1,3,5-tris-(4-aminophenyl)benzene (FIGS. 44)—(1) 4-Nitroacetophenone (10 g), toluene (40 mL), and CF3SO3H (0.6 mL) were introduced to a 100 mL round bottom flask equipped with a condenser and a water separator. The resulting mixture was refluxed for 48 h. During this time, the formed water was eliminated as a toluene azeotrope. After being cooled to room temperature, the resulting solid product was collected by filtration, which was washed with dimethylformamide (DMF) under refluxing and then filtered. This procedure was carried out twice more to yield a pale yellow solid, and the yielded product is insoluble in any common solvent. A suspension of 1 (5 g) and Pd/C (5 wt. %, 1.0 g) in ethanol (150 mL) was heated to reflux. Hydrazine hydrate (20 mL) was added dropwise, and the resulting mixture was further refluxed overnight. The solution was hot filtered through Celite and left undisturbed to crystallize the product fully. The solid was filtered and washed with cold ethanol. ¹H NMR (400 MHZ, d₆-DMSO, 298K, TMS): δ 7.9 (t, 9H, J=5.8 Hz), 6.69 (d, 6H, J=8.4 Hz), 5.22 (s, 6H) ppm.

Synthesis of 2,5-dimethoxyterephthalaldehyde (4) and 2,5-dihydroxy-terephthalaldehyde (5)—To a solution of 1,4-dimethoxybenzene (20.0 g) in 1,4-dioxane (60 mL), formaldehyde solution (37 wt. %, 10 mL), and paraformaldehyde (6.0 g) were added in portions. The resultant mixture was heated to 90° C., and then HCl (37 wt. %, 20 mL) was added in drops. After being heated for another 1 h, HCl (37 wt. %, 60 mL) was introduced, and the resulting mixture was cooled to room temperature to afford a white precipitate, which was collected by filtration, washed with water, and dried under vacuum. The title product was achieved as a white powder after recrystallization from acetone. A mixture of 3 (20.0 g) and hexamethylenetetramine (24.0 g) in CHCl₃ (200 mL) was stirred at 90°° C. for 24 h. After being cooled to room temperature, the pale yellow precipitate was collected by filtration, washed with CHCl₃, dried, and dissolved in water. The aqueous solution was acidified with acetic acid (40 mL) and stirred at 90° C. for another 24 h. The resulting mixture was extracted with CH₂Cl₂, and the organic phase was dried over anhydrous MgSO₄. After solvent evaporation, the residue was recrystallized from ethanol, giving compound 4 as a yellow solid. ¹H NMR (400 MHZ, d₆-DMSO, 298K, TMS) δ10.4 (s, 2H), 7.44 (s, 2H), 3.94 (s, 6H).

2,5-dihydroxyterephthalaldehyde (5). To a solution of 4 (2.0 g) in anhydrous CH₂Cl₂ (100 mL), BBr₃ (2.0 mL) in 50 mL of CH₂Cl₂ was added dropwise at 0° C. under N₂ atmosphere. After being stirred overnight at room temperature, the mixture was cooled to 0° C. and water (20 mL) was added in drops to quench the reaction. The residue was extracted with CH₂Cl₂, washed with brine, dried over MgSO₄, and evaporated under reduced pressure, giving the crude compound which was purified by flash chromatography with hexane/ethyl acetate (5:1) as eluent to afford the title compound as an orange solid. ¹H NMR (400 MHZ, d6-DMSO, 298K, TMS) 810.30 (d, 4H, J-8.8 Hz), 7.23 (s, 2H).

Synthesis of 2,5-bis(2-(2-(2-methoxyethoxy)ethoxy)ethoxy)-terephthalaldehyde-2,5-bis (2-(2-(2-methoxyethoxy)ethoxy)ethoxy)terephthalaldehyde (6)—To a solution of 2,5-dihydroxyterephthalaldehyde (2.76 g, 20.0 mmol) and 1-bromo-2-(2-(2-methoxyethoxy)ethoxy)ethane (13.6 g, 60.0 mmol) in DMF (100 mL) K2CO3 (16.6 g, 120.0 mmol) was introduced at room temperature under stirring. The resulting reaction mixture was heated at 80° C. overnight, quenched with water (100 mL), and extracted with CH₂Cl₂. The combined organic layer was dried over MgSO₄, filtered, and evaporated under reduced pressure, giving the crude compound which was purified by flash chromatography with ethyl acetate/methanol (40:1) as eluent to afford the title compound as a yellow liquid. ¹H NMR (400 MHz, CDCl₃, 298K, TMS) δ10.51 (s, 2H), 7.46 (s, 2H), 4.28 (t, 4H, J=7.2 Hz), 3.91 (t, 4H, J=7.2 Hz), 3.73-3.74 (m, 4H), 3.36-3.74 (m, 8H), 3.54-3.56 (m, 4H), 3.38 (s, 6H).

Synthesis of 2,5-bis(heptyloxy)terephthalaldehyde-2,5-bis(heptyloxy)terephthalaldehyde (7)—To a solution of 2,5-dihydroxyterephthalaldehyde (2.76 g, 20.0 mmol) and 1-bromoheptane (10.7 g, 60.0 mmol) in DMF (100 mL) K₂CO₃ (16.6 g, 120.0 mmol) was added under stirring at room temperature. The resulting reaction mixture was heated at 80° C. overnight, quenched with water (100 mL), and extracted with CH₂Cl₂. The combined organic layer was dried over MgSO₄, filtered, and evaporated under reduced pressure, giving the crude compound which was purified by flash chromatography with hexane/ethyl acetate (5:1) as eluent to afford the title compound as a yellow solid. ¹H NMR (400 MHZ, CDCl₃, 298K, TMS) 810.52 (s, 2H), 7.34 (s, 2H), 4.08 (t, 4H, J=13.2 Hz), 1.84 (t, 4H, J=7.4 Hz), 1.30-1.49 (m, 16H), 0.90 (t, 6H, J=7.0 Hz).

### 3. Fabrication of COFs

COF-4EO—A Schlenk tube (10 mL) was charged with 2,5-bis(2-(2-(2-methoxyethoxy)ethoxy)ethoxy) terephthalaldehyde (68.8 mg, 0.15 mmol) and 1,3,5-tris(4-aminophenyl)benzene (35.1 mg, 0.1 mmol) in 6.0 mL of a 8:2:5 v/v/v solution of 1,4-dioxane/mesitylene/10 M aqueous acetic acid. The tube was flash frozen at 77 K (liquid N₂ bath), evacuated, and sealed. The reaction mixture was heated at 80° C. for 3 days to afford a yellow precipitate which was isolated by filtration and washed with anhydrous tetrahydrofuran (THF) using Soxhlet extraction for 2 d. The product was dried under vacuum to afford COF-4EO.

COF-OHep—A Schlenk tube (10mL) was charged with 2,5-bis(heptyloxy)terephthalaldehyde (54.4 mg, 0.15 mmol) and 1,3,5-tris (4-aminophenyl)benzene (35.1 mg, 0.1 mmol) in 6.0 mL of a 8:2:5 v/v/v solution of 1,4-dioxane/mesitylene/10 M aqueous acetic acid. The tube was flash frozen at 77 K (liquid N₂ bath), evacuated, and sealed. The reaction mixture was heated at 80° C. for 3 days to afford a yellow precipitate which was isolated by filtration and washed with anhydrous tetrahydrofuran (THF) using Soxhlet extraction for 2 d. The product was dried under vacuum to afford COF-OHep.

COF-OMe—A Schlenk tube (10 mL) was charged with 2,5-dimethoxyterephthalaldehyde (29.1 mg, 0.15 mmol) and 1,3,5-tris(4-aminophenyl)benzene (35.1 mg, 0.1 mmol) in 6.0 mL of a 8:2:5 v/v/v solution of 1,4-dioxane/mesitylene/10 M aqueous acetic acid. The tube was flash frozen at 77 K (liquid N₂ bath), evacuated, and sealed. The reaction mixture was heated at 120° C. for 3 days to afford a yellow precipitate which was isolated by filtration and washed with anhydrous tetrahydrofuran (THF) using Soxhlet extraction for 2 d. The product was dried under vacuum to afford COF-OMe.

Dialysis Experiments—Ion diffusion tests were carried out using a homemade diffusion cell. Membrane samples were sandwiched between two polydimethylsiloxane O-rings and sealed in the middle of the cells using clips. The effective area of the membrane samples in the cell was 3.14 cm². In single-salt dialysis diffusion tests, 17 mL of 0.1 M salt solution (LiCl and MgCl₂) was used as the feed solution, and the permeate side was filled with 17 mL of deionized water. The ion concentration of the permeate solution was recorded using ion chromatography (Shimadzu, LC-20A equipped with Shodex IC YS-50 (4.6 mm I.D.×125 mm)). Afterward, the concentration change of the permeate solution over time was obtained based on the linear relationship between the surface area and concentration of salt solutions. A series of salt solutions with various concentrations were prepared, and their surface areas measured by ion chromatography to derive the calibration curves. In binary ion diffusion tests, 17 mL of a salt solution containing 0.1 M LiCl and 0.1 M MgCl₂ was used as the feed solution, and the permeate side was filled with 17 mL of deionized water. The concentrations of Li⁺ and Mg²⁺ in the permeate side were measured by ion chromatography. For membrane recycling, the used membrane was washed with deionized water on the diffusion cell for 6 h. This procedure was carried out twice more before used for the next run. For membrane long-term stability evaluation, the feed solution was cycled with 250 mL of stock salt solution using a peristaltic pump to maintain the ion concentrations, and the permeate solution was connected with a flask filled with deionized water to maintain the liquid level. Other procedures are the same as described above.

Structure Simulation—The crystalline structures of the COFs were constructed using Materials Studio and the geometry and unit cell were optimized by Forcite method. Universal force field and Quasi-Newton algorithm were used for calculation. The XRD pattern simulations were performed in a software package for crystal determination from PXRD pattern, implemented in MS modeling. Pawley refinement was performed to optimize the lattice parameters iteratively until RWP value converged. The pseudo-Voigt profile function was used for whole profile fitting and Berrar-Baldinozzi function was used for asymmetry correction during the refinement processes. The RWP values for COF-4EO, COF-OHep, and COF-OMe were 5.6%, 5.1%, and 2.2%, respectively.

Computational Methods—Quantum chemical calculations were performed with the Gaussian 09 D.01 software. The density functional theory (DFT) approach was adopted for the calculations using the M062X2 density functional and the 6-311G* basis set for all the atoms. Using the gas-phase geometries, implicit solvent corrections were obtained at 298 K with the SMD3 solvation model as implemented in Gaussian 09 at the B3LYP/SSC/6-31+G (d) level of theory. The results are reported using the lowest energy clusters identified at the M062X/SSC/6-311 G* level for a given stoichiometry and binding motif.

Characterization—The N₂ sorption isotherms were measured at 77 K using a liquid N₂ bath. Powder X-ray diffraction (PXRD) data were collected on a Bruker AXS D8 Advance A25 powder X-ray diffractometer (40 kV, 40 mA) using Cu Kα (2=1.5406 Å) radiation. Scanning electron microscopy (SEM) images were collected using a Hitachi SU 8010. FT-IR spectra were recorded on a Nicolet Impact 410 FTIR spectrometer. ICP-OES was performed on a Perkin-Elmer Elan DRC II Quadrupole. X-ray photoelectron spectroscopy (XPS) spectra were performed on a Thermo ESCALAB 250 with Al Kα irradiation at θ=90° for X-ray sources, and the binding energies were calibrated using the C1s peak at 284.9 eV. ¹H NMR spectra were recorded on a Bruker Avance-400 (400 MHZ) spectrometer. Chemical shifts are expressed in ppm downfield from TMS at δ=0 ppm, and J values are given in Hz. Static solid-state ⁷Li NMR experiments were recorded on a Bruker Avance 500 spectrometer equipped with a magic-angle spin probe in a 4-mm ZrO₂ rotor. Grazing incidence wide-angle X-ray scattering (GIWAXS) measurements were conducted on a MicroMax-007HF with a high-intensity Microfocus rotating anode X-ray generator at an incident angle of 0.2°. The samples were recorded in the 20 range of 2-40° and the data were collected with Win software. Two-dimensional grazing incidence wide-angle X-ray scattering (2D-GIWAXS) was conducted to analyze the orientation of the COF layer by using a XEUSS SAXS/WAXS system at an incident angle of 0.2°. The membrane samples were cut into small pieces (1 cm×1 cm) and then attached to a silicon wafer. 2D-GIWAXS data of membranes were evaluated using a MarCDD X-ray detector.

COF-based membranes implanted with oligoethers have demonstrated their utility as Lithium-selective diffusion membranes. The transport of Li⁺ ions is accelerated by rapid and reversible coordination with the ether moieties, thereby differentiating Li⁺ ions from other ions. Theoretical and spectroscopic studies were carried out to explain the observed selective extraction efficiency based on the interaction and dynamic exchange between oligoethers and Li⁺ ions. The synergistic effect between the densely-populated lithiophilic sites and the one-dimensional channels promotes significantly faster ion transport rates and allows the use of thicker films. The performance is enduring, as reflected by the fact that the selectivity was retained under the same conditions for at least 40 h.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A crystalline, modular covalent organic framework of formula I: 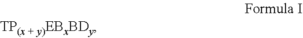
wherein TP is derived from formula II: 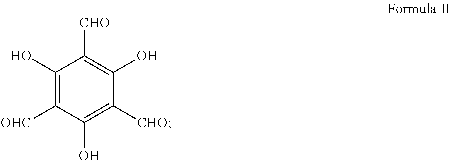 [SMILES: O=Cc1c(O)c(C=O)c(O)c(C=O)c1O]
wherein EB is derived from formula III: 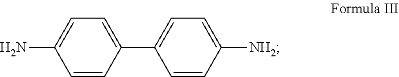 [SMILES: Nc1ccc(-c2ccc(N)cc2)cc1]
wherein BD is derived from formula IV: 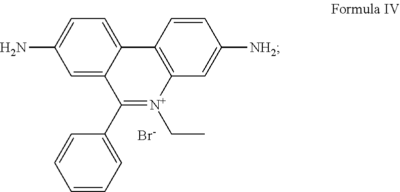
wherein x is an integer ranging from 1 to 5; and
wherein y is an integer ranging from 1 to 5.

2. The covalent organic framework of claim 1, wherein the covalent organic framework comprises a plurality of imine functional groups, each of which is derived from reaction between an aldehyde group and an amine group.

3. The covalent organic framework of claim 1, wherein the covalent organic framework has a cyclic structure and comprises a repeating unit represented by formula V: 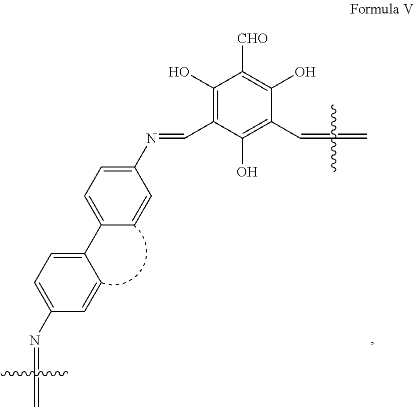
wherein a portion of the repeating unit represented by formula VI: 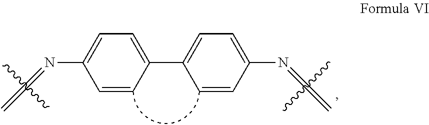
represents one of BD and EB.

4. The covalent organic framework of claim 1, wherein the covalent organic framework is provided on a support membrane.

5. The covalent organic framework of claim 4, wherein the support membrane comprises polyacrylonitrile.

6. The covalent organic framework of claim 5, wherein the polyacrylonitrile membrane is a partially-hydrolyzed ultrafiltration polyacrylonitrile membrane.

7. The covalent organic framework of claim 1, wherein the covalent organic framework comprises cylindrical nanochannels.

8. The covalent organic framework of claim 7, wherein a nanochannel internal diameter of the cylindrical nanochannels is in the range of in the range of 0.8-4.8 nm.

9. The covalent organic framework of claim 7, wherein a nanochannel internal diameter of the cylindrical nanochannels is adjustable, and wherein diameter adjustment of the nanochannel internal diameter is based on selection of x and y.

10. The covalent organic framework of claim 1, wherein the covalent organic framework exhibits operational stability for up to 2 months under constant diffusion dialysis and electrodialysis conditions.

11. The covalent organic framework of claim 1, wherein the covalent organic framework exhibits higher permeability to cationic lithium over cationic magnesium.

12. A cyclic, crystalline, covalent organic framework comprising monomer units A and B,
wherein monomer A is derived from formula VII: 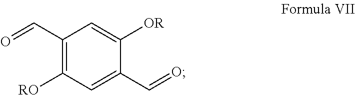
wherein R is an alkyl group of from 1 to 8 carbon atoms or an ethylene oxide chain comprising from 2 to 4 ethylene oxide groups;
wherein B is derived from formula VIII: 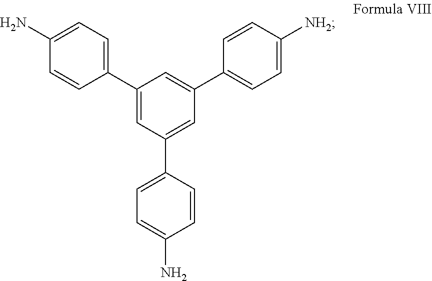 [SMILES: Nc1ccc(-c2cc(-c3ccc(N)cc3)cc(-c3ccc(N)cc3)c2)cc1]
and
wherein the number of A monomer units in the covalent organic framework is equal to the number of B monomer units.

13. The covalent organic framework of claim 12, wherein the covalent organic framework comprises a plurality of imine functional groups, each of which is derived from a monomer A aldehyde group and a monomer B amine group.

14. The covalent organic framework of claim 12, wherein the covalent organic framework comprises a repeating unit represented by formula IX:

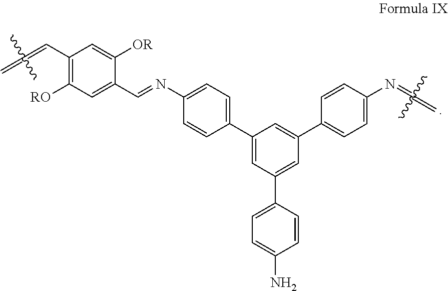

15. The covalent organic framework of claim 14, wherein the covalent organic framework comprises 6 repeating units.

16. The covalent organic framework of claim 12, wherein the covalent organic framework is provided on a support membrane.

17. The covalent organic framework of claim 16, wherein the support membrane comprises polyacrylonitrile.

18. The covalent organic framework of claim 12, wherein the monomer A is an ethylene oxide chain that terminates in a methyl group.

19. The covalent organic framework of claim 12, wherein the monomer A is derived from formula X:

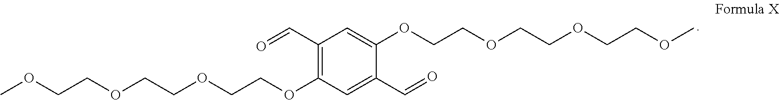

20. The covalent organic framework of claim 12, wherein the monomer A is derived from formula XI:

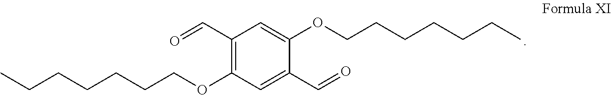 [SMILES: CCCCCCCOc1cc(C=O)c(OCCCCCCC)cc1C=O]

21. The covalent organic framework of claim 12, wherein the monomer A is derived from formula XII:

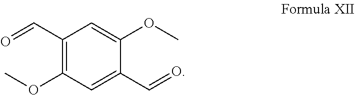

22. The covalent organic framework of claim 12, wherein the covalent organic framework exhibits higher permeability to cationic lithium over cationic magnesium.

23. The covalent organic framework of claim 12, wherein the covalent organic framework exhibits operational stability for up to 2 months under constant diffusion dialysis and electrodialysis conditions.

24. A method of separating a cationic species from a mixture of cationic species, the method comprising:
employing a filtration membrane comprising a polyacrylonitrile support and a covalent organic framework of formula XIII provided on the polyacrylonitrile support: 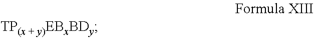
wherein TP is derived from formula XIV: 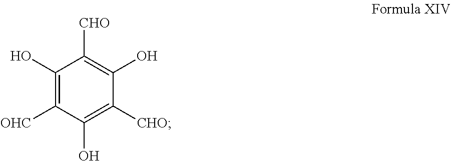 [SMILES: O=Cc1c(O)c(C=O)c(O)c(C=O)c1O]
wherein EB is derived from formula XV: 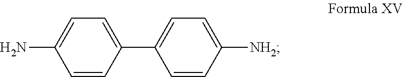 [SMILES: Nc1ccc(-c2ccc(N)cc2)cc1]
wherein BD is derived from Formula XVI: 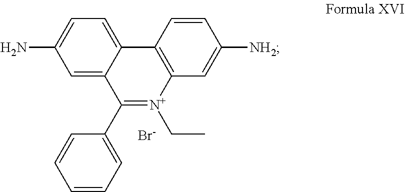
wherein x is an integer ranging from 1 to 5; and
wherein y is an integer ranging from 1 to 5.

25. The method of claim 24, wherein a ratio of x: y is adjusted to modify selectivity for a particular cationic species through the filtration membrane.

26. The method of claim 24, further comprising separating cationic lithium from a mixture of cations.

27. The method of claim 26, wherein the mixture of cations comprises the cationic lithium and cationic magnesium.

28. A method of separating a cationic species from a mixture of cationic species, the method comprising:
employing a filtration membrane comprising employing a cyclic, crystalline, covalent organic framework comprising monomer units A and B,
wherein monomer A is derived from formula XVII: 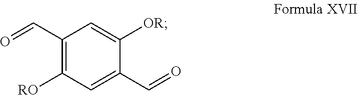
wherein R is an alkyl group of from 1 to 8 carbon atoms or an ethylene oxide chain comprising from 2 to 4 ethylene oxide groups;
wherein monomer B is derived from formula XVIII: 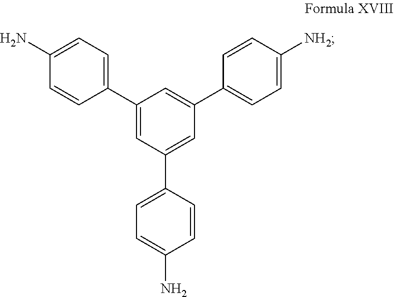 [SMILES: Nc1ccc(-c2cc(-c3ccc(N)cc3)cc(-c3ccc(N)cc3)c2)cc1]
wherein the number of A monomer units in the covalent organic framework is equal to the number of B monomer units; and
wherein the covalent organic framework is provided on a polyacrylonitrile support.

29. The method of claim 28, wherein the R alkyl group is selected to adjust cation diffusion selectivity through the filtration membrane.

30. The method of claim 28, further comprising separating cationic lithium from a mixture of cations.

31. The method of claim 28, wherein the mixture of cations comprises cationic lithium and cationic magnesium.
